(19) United States
(12) Patent Application Publication
(10) Pub. No.: US 2010/0161805 A1
(43) Pub. Date: Jun. 24, 2010

(54) SURPLUS RESOURCE MANAGEMENT SYSTEM, METHOD AND SERVER

(75) Inventors: Masahiro YOSHIZAWA, Kokubunji (JP); Hideki Okita, Fuchu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/640,530

(22) Filed: Dec. 17, 2009

(30) Foreign Application Priority Data
Dec. 22, 2008 (JP) 2008-324848

(51) Int. Cl. G06F 15/173

(52) U.S. Cl. 709/226; 718/1

(57) ABSTRACT

In a system having physical machine resources and network component resources, a resource management technique is provided that is effective for deploying virtual machines utilizing these resources. A surplus policy regarding surplus resources is prepared as a parameter adjustable by the system administrator. A placement plan generating program at a VM placement plan generating server generates placement plans for virtual machines in response to alteration of the surplus policy. Then, a placement plan verification program at the VM placement plan generating server validates whether each of the created placement plans complies with the altered surplus policy. This validation is performed by simulating the amounts of utilization of both physical machine resources and network component resources. The VM placement plan generating server presents the placement plans that passed this validation, as those causing no problem in performance, to the system administrator through the use of an administrator terminal.

### CLAIM OF PRIORITY

The present application claims priority from Japanese patent application JP 2008-324848 filed on Dec. 22, 2008, the content of which is hereby incorporated by reference into this application.

### FIELD OF THE INVENTION

The present invention relates to management of resources of a system composed of various types of equipment units, particularly, to a resource management technique for deploying virtual machines in a system having virtualized server resources, network resources, and the like.

### BACKGROUND OF THE INVENTION

Due to the development of virtual techniques during late years, data center operators have begun to provide a service of generating a virtual machine environment on demand.

In such a service, virtual machines having significantly different amounts of resources required would coexist in one data center. For example, virtual machines making much use of a Central Processing Unit (CPU) as resources, but making little use of a network bandwidth as resources might coexist with virtual machines making little use of CPU, but consuming a lot of network bandwidth. This is due to that one data center has become capable of serving multiple customers by virtualization of both servers and networks.

The above service typically leases virtual machines to customers after assuring a minimum amount of available resources. FIG. 26 schematically illustrates a framework of this service. In the following description, after the sum of minimum amounts of resources to be assured for each virtual machine is subtracted from a maximum amount of resources of each unit of equipment (physical machines, network equipments such as switches, storage devices, etc.), the remaining resources are termed a surplus in the resources. To provide minimum assured resources surely, this surplus is typically reserved when a service is provided.

In the above service, there is the following trade-off regarding the surplus in diverse resources.

(1) If the surplus is too small, minimum resources promised to customers may fail to be assured (a problem in terms of performance may arise).
(2) If the surplus is too large, the number of equipment units that need to be worked increases. In consequence, more power than required will be consumed and the operation cost may increase.

To adjust such surplus resources, a system administrator needs to redeploy virtual machines running on the equipment units. Because a lot of equipment units are handled for services of a data center, decreasing the number of equipment units that need to be worked in both server and network aspects, if possible, to the extent that no problem in performance occurs, has a large effect on the power consumption and the operation cost.

However, redeployment of virtual machines only in view of the surplus in one type of resources may cause a risk that it affects the surpluses in other resources and has an adverse effect on their performance. For example, the redeployment of virtual machines only in view of the surplus in CPU resources only may create a switch having only a small surplus of bandwidth and may give rise to a problem in the performance of the switch. Therefore, there is a need for means for allowing the system administrator to find a risk-free placement plan.

As a method for recommending a risk-free deployment of virtual machines, a method is publicly known in which utilization ratios of resources are calculated beforehand and a deployment resulting in leveling of the utilization ratios is recommended (reference; JP-A-2007-133586). As a patent relating to a Storage Area Network (hereinafter abbreviated to SAN), a method that simulates whether redeploying a storage volume is risk-free, taking the bandwidths of network paths into account, is publicly known (reference; JP-A-2004-072135).

As another patent relating to the SAN, a method that allocates storage device resources as physical machines to virtual machines (virtual disks), wherein an upper limit of allocation is determined by storage device performance information, is also publicly known (reference; JP-T-2008-527555).

### SUMMARY OF THE INVENTION

In the methods described in the above references, a parameter for adjusting surplus resources is not provided to the system administrator and it is difficult to recommend a deployment resulting in a surplus decrease. In these methods, no consideration is taken for altering the surpluses in physical machine resources and network component resources at the same time.

An object of the present invention is to provide a surplus resource management system, a management method thereof, and a server for recommending a risk-free deployment causing no problem in performance, based on adjustment of a surplus in resources.

Another object of the present invention is to provide a user interface suitable for adjusting a surplus in resources to the system administrator.

To achieve the above objects, the present invention provides a surplus resource management system wherein management of resources is performed by a server, wherein the server comprises a placement plan generating unit that generates at least one placement plan for virtual machines which are provided by utilizing the resources, based on a difference between a first surplus policy regarding a current surplus in the resources and a second surplus policy regarding a new surplus in the resources, and a management method thereof.

The invention also provides the surplus resource management system wherein the server comprises a placement plan validating unit that validates whether each of the created placement plans for virtual machines is rejected by a new second surplus policy, and a management method thereof.

The invention further provides the surplus resource management system wherein the server comprises, besides the placement plan validating unit that validates whether each of the created placement plans for virtual machines is rejected by a new second surplus policy, a surplus policy adjusting unit that adjusts a value included in the new second surplus policy used to create the placement plans, based on results of validation by the placement plan validating unit, and generates a further surplus policy, and a management method thereof.

The invention further provides, as a server for use in this surplus resource management system, a server for management of resources, including a processing part and a storage part, wherein the processing part comprises a placement plan generating unit that generates placement plans for virtual machines which are provided by utilizing the resources, based on a difference between a first surplus policy regarding a current surplus in the resources and a second surplus policy regarding a new surplus in the resources.

More specifically, in the present invention, a surplus policy regarding surplus resources is prepared as a parameter adjustable by the system administrator, wherein a system such as a data center must comply with the surplus policy. This surplus policy represents a policy regarding surplus resources relative to a criterion such as a proportion of surplus resources to a maximum amount of the resources (hereinafter referred to as a surplus ratio) and an absolute amount of surplus. By way of example, the surplus policy may be defined as follows: e.g., “the surplus ratios of the CPUs of all physical machines are equal to or above 30%” and “the absolute amounts of surplus bandwidths of all switches are equal to or above 200 Mbps”.

In a preferred aspect of the server for generating placement plans in accordance with the present invention, when the system administrator has altered the surplus policy, the server generates placement plans (redeployment patterns) for virtual machines in response to a surplus change in the surplus policy. When doing so, the VM placement plan generating server generates placement plans fewer than all possible placement plans for virtual machines, taking account of a direction of surplus change and a surplus variable range in the surplus policy.

Then, the VM placement plan generating server validates whether each of the created placement plans complies with the altered surplus policy. This validation is performed by simulating the amounts of utilization of both physical machine resources and network component resources. In consequence, the VM placement plan generating server presents the placement plans that passed the above validation, as those causing no problem in performance, to the system administrator.

The system administrator is allowed to easily review a deployment of virtual machines after an assumed surplus increase or decrease in the resources. Thereby, the system administrator can instinctively perceive a relation between surplus resources and virtual machine deployment.

Further, the VM placement plan generating server takes both physical machine resources and network component resources into account, when generating placement plans for virtual machines. Thereby, it is possible to reduce the possibility that virtual machine redeployment may give rise to another problem in performance in other locations.

Thus, the surplus resource management system and method as well as the server of the present invention can improve convenience for the administrator of a system such as a data center.

### BRIEF DESCRIPTION OF THE DRAWINGS

FIG. 1 is a diagram showing an overview of a data center system;

FIG. 2 is a diagram showing a physical structure of a VM placement plan generating server assumed to be used in the first embodiment;

FIG. 3 is a sequence diagram of a phase wherein the system administrator enters data necessary for a series of processing in the first embodiment;

FIG. 4 is a sequence diagram of a phase wherein the VM placement plan generating server generates placement plans, involved in the first embodiment;

FIG. 5 is a sequence diagram of a phase wherein the VM placement plan generating server generates a system reconfiguration procedure, involved in the first embodiment;

FIG. 6 shows a flowchart of a placement plan generating program in the first embodiment;

FIG. 7 shows a flowchart of the placement plan generating program in the first embodiment;

FIG. 8 shows a flowchart of a placement plan verification program in the first embodiment;

FIG. 9 shows an input screen for system configuration at an administrative client (administrator terminal) in the first embodiment;

FIG. 10 shows an input screen for virtual machine data at the administrative client in the first embodiment;

FIG. 11 shows an input screen for surplus policy data at the administrative client in the first embodiment;

FIG. 12 shows an input screen for surplus policy alteration at the administrative client in the first embodiment;

FIG. 13 shows a screen for displaying placement plan data at the administrative client in the first embodiment;

FIG. 14 shows exemplary equipment data for the first embodiment 1;

FIG. 15 shows exemplary link data for the first embodiment 1;

FIG. 16 shows exemplary resource data for the first embodiment 1;

FIG. 17 shows exemplary virtual machine requirement data for the first embodiment 1;

FIG. 18 shows exemplary virtual machine location data for the first embodiment 1;

FIG. 19 shows exemplary virtual machine network path data for the first embodiment 1;

FIG. 20 shows exemplary surplus policy data for the first embodiment 1;

FIG. 21 is a diagram showing a physical structure of a VM placement plan generating server pertaining to a second embodiment;

FIG. 22 is a sequence diagram of a phase wherein the VM placement plan generating server generates placement plans and another surplus policy, involved in the second embodiment;

FIG. 23 shows a flowchart of the placement plan verification program in the second embodiment;

FIG. 24 shows exemplary validation results in the second embodiment;

FIG. 25 shows a flowchart of the placement plan verification program in the second embodiment; and

FIG. 26 is a diagram to explain surplus definition pertaining to each embodiment.

### DETAILED DESCRIPTION OF THE PREFERRED EMBODIMENTS

Various embodiments of the present invention will be described hereinafter, according to the drawings. In the description herein, it should be noted that a current surplus policy may be termed a first surplus policy and a new surplus policy may be termed a second surplus policy. It also should be noted that a program, e.g., a “placement plan generating program” that is stored in the memory of a server and executed by the CPU may be termed a “unit” such as a “placement plan generating unit”.

### First Embodiment

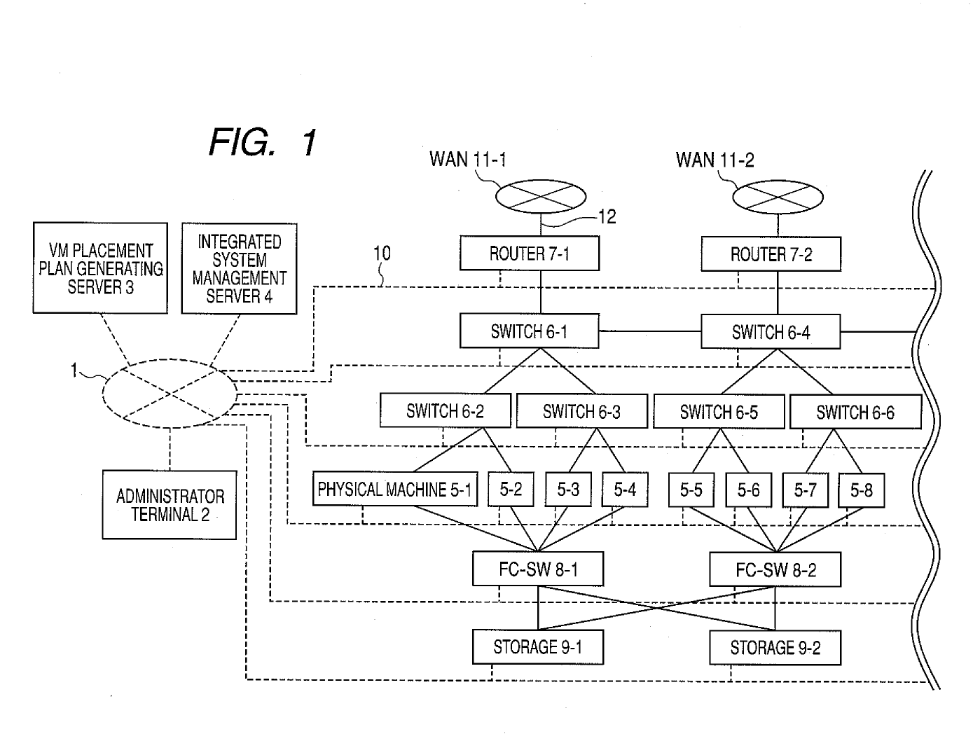

FIG. 1 schematically shows a data center system that is assumed to be a system in which the first and subsequent embodiments are implemented. This virtualized system is composed of an administrator terminal 2 which is an administrative client, a VM placement plan generating server 3, an integrated system management server 4, a plurality of physical machines 5, a plurality of switches 6, a plurality of routers 7, a plurality of fiber channel switches 8 (hereinafter abbreviated to FC-SWs), and storages 9.

The administrator terminal 2, the VM placement plan generating server 3, and the integrated system management server 4 are commonly-used computer systems having a Central Processing Unit (CPU), a memory as a storage part, an interface (I/F) part, an input/output part, and other elements. Although they are shown with separate computer systems, a set of them may be comprised of a fewer number of computer systems by, e.g., implementing the VM placement plan generating server 3 and the integrated system management server 4 as a single server.

These units of equipment are connected to a managerial network 1 through physical communication lines 10. The physical machines 5, switches 6, routers 7, FC-SWs 8, and storages 9 are interconnected through communication lines 12. The routers 7 are connected to Wide Area Networks (WANs) 11 that customers of the data center use.

The administrator terminal 2 is a terminal that can be used exclusively by a system administrator. On the administrator terminal 2, software (hereinafter referred to as administration software) for making use of the VM placement plan generating server 3 and the integrated system management server 4 runs. The administration software comprises a GUI (Graphical User Interface) using a dedicated communication protocol and a Web browser for HTTP (HyperText Transfer Protocol) based communication.

The VM placement plan generating server 3 generates anew placement plan for virtual machines, based on information provided from the administrator terminal 2 which is an administrative client. The VM placement plan generating server 3 not only generates a placement plan, but also it can reconfigure a real environment based on the placement plan via the integrated system management server 4.

The integrated system management server 4 redeploys virtual machines and reconfigures virtual networks (such as VLAN configuration), based on information provided from the administrator terminal 2 or the VM placement plan generating server 3. The integrated system management server 4 connects to managerial ports of the physical machines 5 and others via the managerial network 1 and changes various configurations.

Each physical machine 5 is a server entity allowing a virtual machine to operate on it. One method for operating a virtual machine on a physical machine 5 may be, for example, running software that is generally called a “hypervisor” or a “virtual machine monitor”. Through a managerial interface of a physical machine 5, the integrated system management server 4 is able to change a virtual machine operating on the physical machine.

Each switch 6 is a network component that mediates traffic between a router 7 and a virtual machine operating on a physical machine 5. Because multiple traffic flows of a plurality of customers occur in the data center network of the present embodiment, the switches 6 need to support a virtualization function (such as VLAN) to provide virtually separate networks per customer. Through a managerial interface of a switch 6, the integrated system management server 4 is able to, reconfigure the virtualization function of the switch.

Each router 7 is a network component that connects the data center network to one of the WANs 11 that customers use. If customers use a wide-area Ethernet (a registered trademark) as the WAN, a switch may be located in place of the router. Through a managerial interface of a router 7, the integrated system management server 4 is able to reconfigure the virtualization function of the router.

Each FC-SW 8 is network component that mediates traffic between a virtual machine operating on a physical machine 5 and a storage 9. Because multiple traffic flows of a plurality of customers occur in the data center network of the present embodiment, the FC-SWs 8 need to support a virtualization function (such as zoning and VSAN) to provide virtually separate networks per customer. Through a managerial interface of an FC-SW 8, the integrated system management server 4 is able to reconfigure the virtualization function of the FC-SW.

Each storage 9 is a unit of equipment provided to store data to be used by virtual machines. A storage 9 provides a virtual machine with its boot area and data area. Through a managerial interface of a storage 9, the integrated system management server 4 is able to reconfigure the virtualization function of the storage.

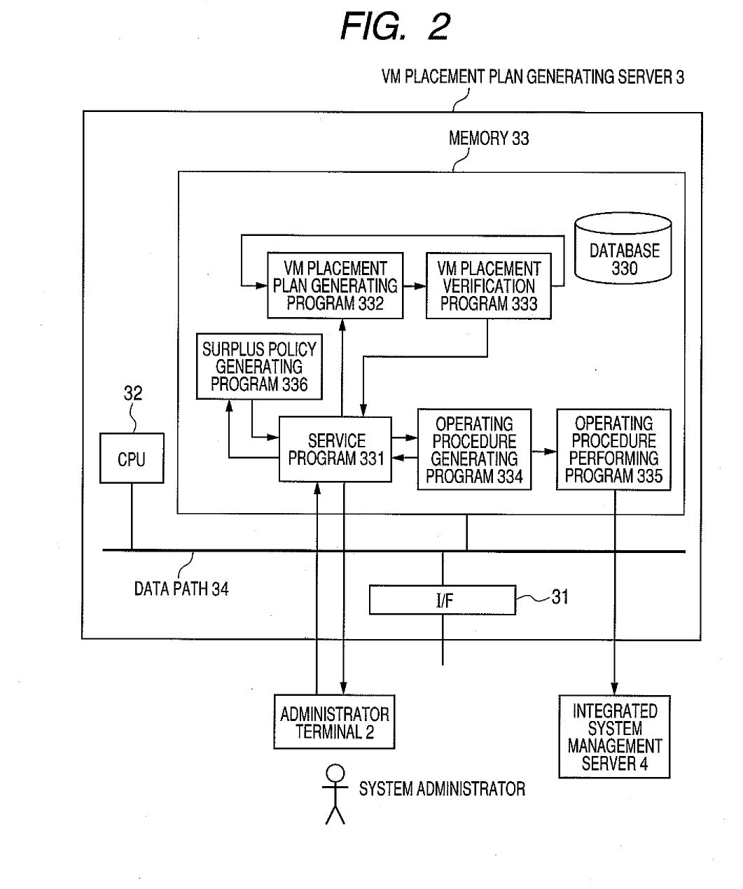

FIG. 2 is a functional block diagram showing one example of an internal structure of a VM placement plan generating server 3 which is used in the data center system as the first embodiment of the resource management system. The VM placement plan generating server 3 transmits and receives packets through an interface (I/F) part 31. Programs for the VM placement plan generating server 3 are stored in a memory 33. During operation, CPU 32 which is a processing part reads these programs through a data path 34 and executes them. Arrows in the figure indicate flows of data between programs. In this structure, the administrator terminal 2 serves as an input/output part for the VM placement plan generating server 3.

The memory 33 stores a database 330, a service program 331, a placement plan generating program 332, a placement plan verification program 333, an operation procedure generating program 334, an operation procedure performing program 335, and a surplus policy generating program 336.

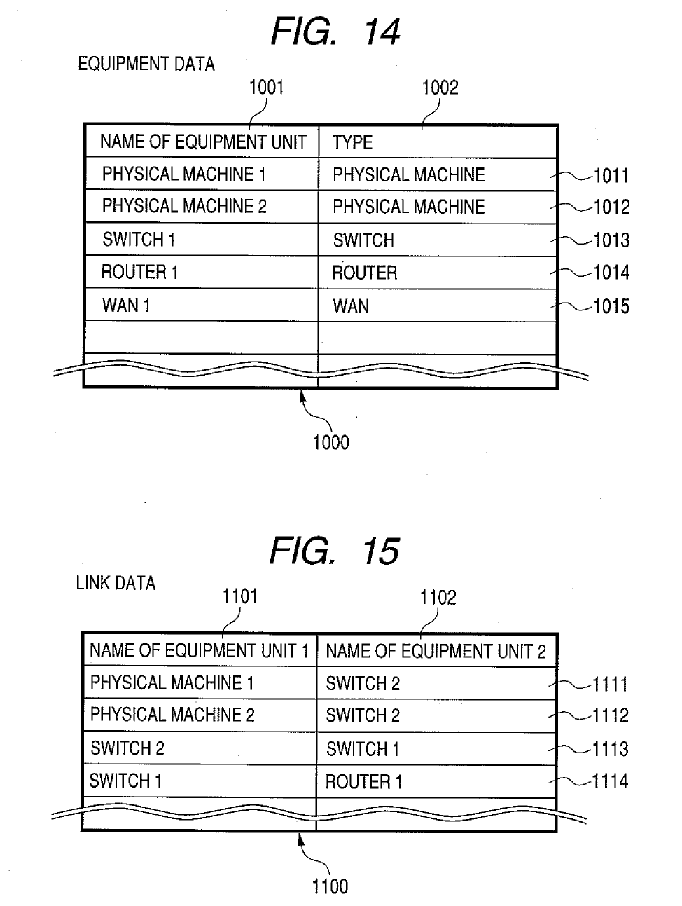

The database 330 stores data required for operation of the VM placement plan generating server 3. Such data includes equipment data 1000, link data 1100, resource data 1200, virtual machine requirement data 1300, virtual machine location data 1400, virtual machine network path data 1500, and surplus policy data 1600. In the present embodiment, all these sets of data are assumed to be stored in respective tables, as exemplarily shown in FIGS. 14 to 20.

FIG. 14 shows exemplary equipment data. Equipment data 1000 represents equipment units available in the data center system. A column 1001 is for the name of an equipment unit for uniquely identifying a particular equipment unit in the present system. A column 1002 is for the type of an equipment unit. In the present embodiment, it is assumed that there are several types of equipment; i.e., “physical machine”, “switch”, “router”, “WAN”, “FC-SW”, and “rage”.

FIG. 15 shows exemplary link data. Link data 1100 represents connections between equipment units configured in the equipment data 1000. A column 1101 is for the name of a equipment unit located at one end of a link. A column 1102 is for the name of an equipment unit located at the other end of the link.

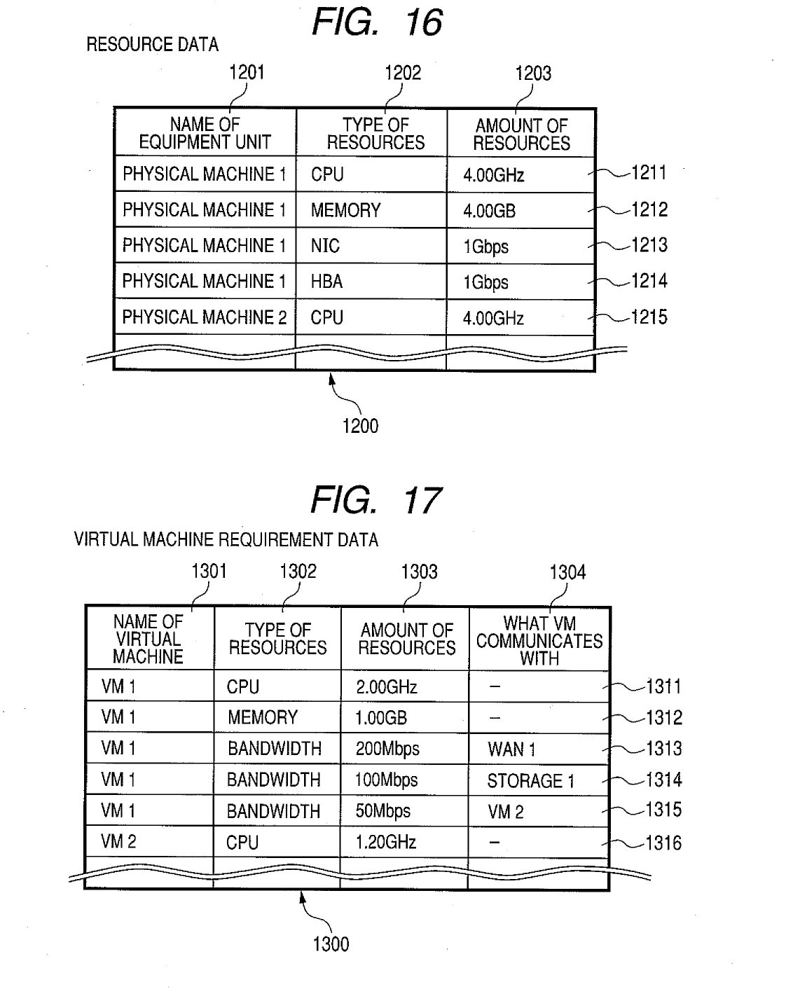

FIG. 16 shows exemplary resource data 1200. Resource data 1200 represents resources that the equipment units configured in the equipment data 1000 have. Resources termed herein include CPU of a physical machine, memory, bandwidth of an NIC (Network Interface Card), and bandwidth of an HBA (Host Bus Adapter) of a fiber channel. The amount of data that can be processed by a network component per unit of, time and bandwidth of each port of a network component are also included in the resources. A column 1201 is for the name of an equipment unit and a column 1202 is for the type of resources. A column 1203 is for the amount of resources of the type indicated in the column 1202 for the equipment unit indicated in the column 1201.

FIG. 17 shows exemplary virtual machine requirement data 1300. Virtual machine requirement data 1300 represents virtual machines that need to be operated in the data center system and resources that should be assured at minimum for each virtual machine. A column 1301 is for the name of a virtual machine for uniquely identifying a particular virtual machine in the present system. A column 1302 is for the type of resources and a column 1303 is for the amount of resources of the type that should be assured at minimum. A column 1304 is for what the virtual machine communicates with. Only if the type of resources is “bandwidth”, what the VM communicates with needs to be registered. Data of what the VM communicates with is used for calculating the amount of bandwidth used by a network component.

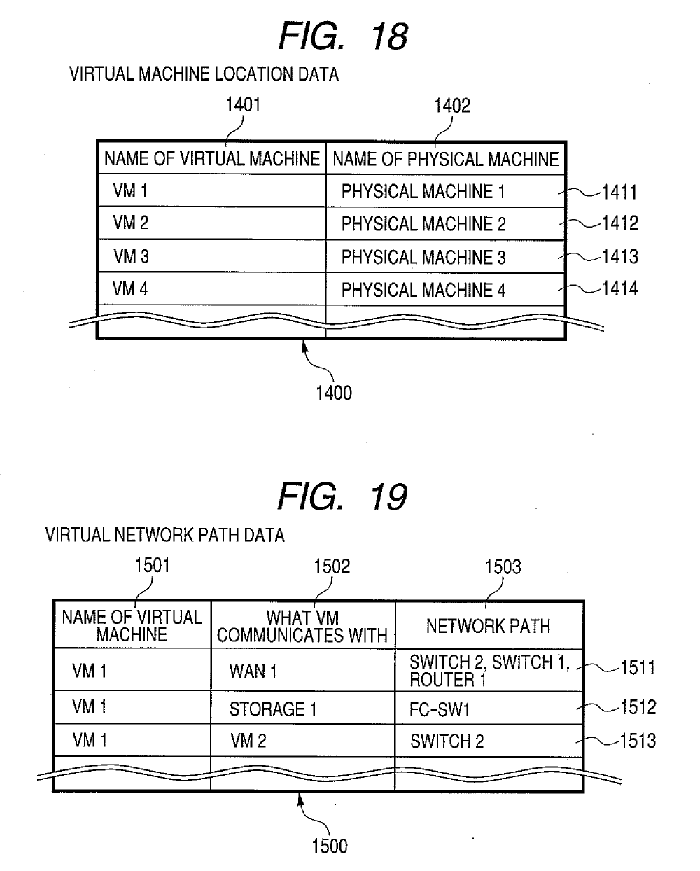

FIG. 18 shows exemplary virtual machine location data. Virtual machine location data 1400 represents which physical machine on which each virtual machine operates. A column 1401 is for the name of a virtual machine and a column 1402 is for the name of a physical machine on which the virtual machine operates.

FIG. 19 shows exemplary virtual machine network path data. Virtual machine network path data 1500 represents a network path through which traffic originated by each virtual machine passes. A column 1501 is for the name of a virtual machine, a column 1502 is for what the VM communicates with, and a column 1503 is for a network path via which the virtual machine communicates with what it communicates with.

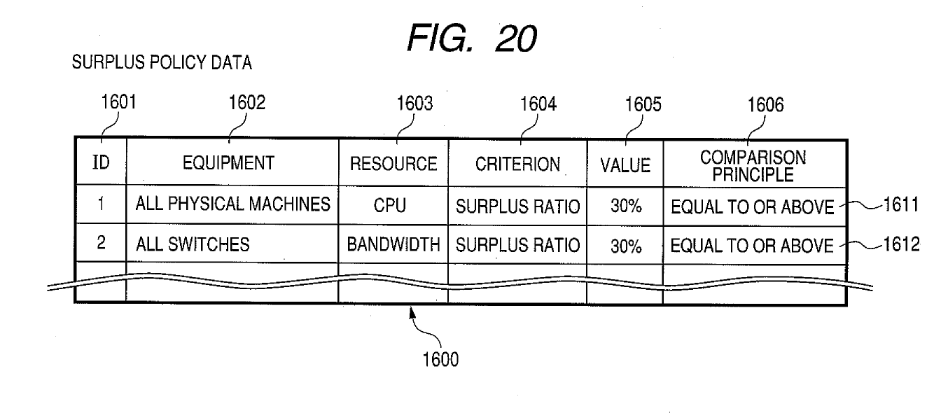

FIG. 20 shows exemplary surplus policy data. Surplus policy data 1600 represents a surplus policy that the data center system complies with. In the present embodiment, a surplus policy regarding surplus resources of equipment units is prepared and the data center system must always comply with this policy as a parameter that is adjustable by the system administrator. This surplus policy represents a policy regarding surplus resources, based on a criterion that is a ratio of surplus resources to the maximum amount of a certain type of resources (hereinafter referred to as a surplus ratio) or an absolute amount of surplus. By way of example, as already discussed, surplus policy items may be defined as follows: e.g., “the surplus ratios of the CPUs of all physical machines are equal to or above 30%” and “the absolute amounts of surplus bandwidths of all switches are equal to or above 200 Mbps”.

In FIG. 20, a column 1601 is for ID to uniquely identify a surplus policy item in the present system. A column 1602 is for equipment for which it should be judged whether the surplus policy is validated. A column 1603 is for resources for which it should be judged whether the surplus policy is validated. A column 1604 is for the criterion of the validation, a column 1605 is for a value that is used for the validation, and a column 1606 is for a comparison principle. The equipment 1602 for which it should be judged whether the surplus policy is validated may be all units of equipment (e.g., all physical machines), a subset of equipment (e.g., physical machines 1, 2, and 3), or a designated unit of equipment (e.g., a switch of product A), among others. The criterion 1604 of the validation may be a surplus ratio, an absolute amount of surplus, among others. The value 1605 that is used for the validation may be specified as a proportion (e.g., 30%) if the criterion of the validation is a surplus ratio or a value (e.g., 300 Mbps) if the criterion of the validation is an absolute amount of surplus. The comparison principle 1606 may be “equal to or above (including an equal value)”, “more than (not including an equal value)”, among others.

For example, a surplus policy in a row 1611 (ID 1) indicates that “it rejects a deployment contravening a condition that the surplus ratios of the CPUs of all physical machines are equal to or above 30%”. The placement plan verification program 333 which will be described later rejects a placement plan contravening a surplus policy included in the surplus policy data 1600.

In a case where the system administrator wishes for load leveling, a difference between surplus ratios may be used. If a difference between surplus ratios is used as the criterion, it is possible to create, for example, a surplus policy that “rejects a deployment contravening a condition that a difference between the surplus ratios of the CPUs of two physical machines is less than 30%”.

The service program 331 in the memory 33 shown in FIG. 2 is a program to transmit and receive data to/from administration software running on the administrator terminal 2. The service program 331 registers data input from the administrator terminal 2 into the database 330. The service program 331 invokes the placement plan generating program 332 or the operation procedure generating program 334, according to input by the system administrator.

The placement plan generating program 332 is a program to create placement plans for virtual machines, according to input by the system administrator. When doing so, the placement plan generating program 332 generates placement plans fewer than all possible placement plans for virtual machines, taking account of a direction of surplus change and a surplus variable range in a surplus policy. Incidentally, given that the number of physical machines is P and the number of virtual machines is V, the number of possible placement plans for virtual machines is P raised to the power V.

A placement plan that is created by the placement plan generating program 332 includes location data and network path data on all virtual machines. These data structures are the same as the virtual machine location data 1400 and the virtual machine network path data 1500.

The placement plan verification program 333 is a program that validates a placement plan created by the placement plan generating program 332 and rejects a placement plan contravening a surplus policy that has been input by the system administrator. This validation is based on simulating how much resources are used with regard to both physical machine resources and network component resources. The placement plan verification program 333 returns only a placement plan that passed the above validation as the placement plan causing no problem in performance to the service program 331.

The operation procedure generating program 334 is a program to create an operating procedure that is necessary when redeploying virtual machines from the current deployment to a new deployment. The new deployment is, that is, a placement plan created by the placement plan generating program 332. The operating procedure includes relocating virtual machines and reconfiguring virtual networks (e.g., reconfiguring VLANs).

There are two ways of using an operating procedure thus created. In one way of its use, according to the operating procedure, the system administrator reconfigures virtual machines and virtual networks. In this case, the operation procedure generating program 334 returns the operating procedure created by it to the administrator terminal 2 via the service program 331. At this time, the operating procedure is expressed in a form such as text that can be read by the system administrator and commands that can be interpreted by the integrated system management server 4.

In another way of its use, according to the operating procedure, the VM placement plan generating server 3 itself reconfigures virtual machines and virtual networks. In this case, the operation procedure generating program 334 passes the operating procedure to the operation procedure performing program 335. The operation procedure performing program 335 communicates with the integrated system management server 4 to reconfigure virtual machines and virtual networks.

The operation procedure performing program 335 is a program that instructs the integrated system management server 4 to perform various reconfigurations according to the operating procedure created by the operation procedure generating program 334. In the case that the system administrator directly reconfigures virtual machines and virtual networks, this program is not needed.

The surplus policy generating program 336 is a program that automatically generates a different surplus policy based on the surplus policy after reconfiguration specified by the system administrator. If automatic surplus policy creation is not performed, this program is not needed.

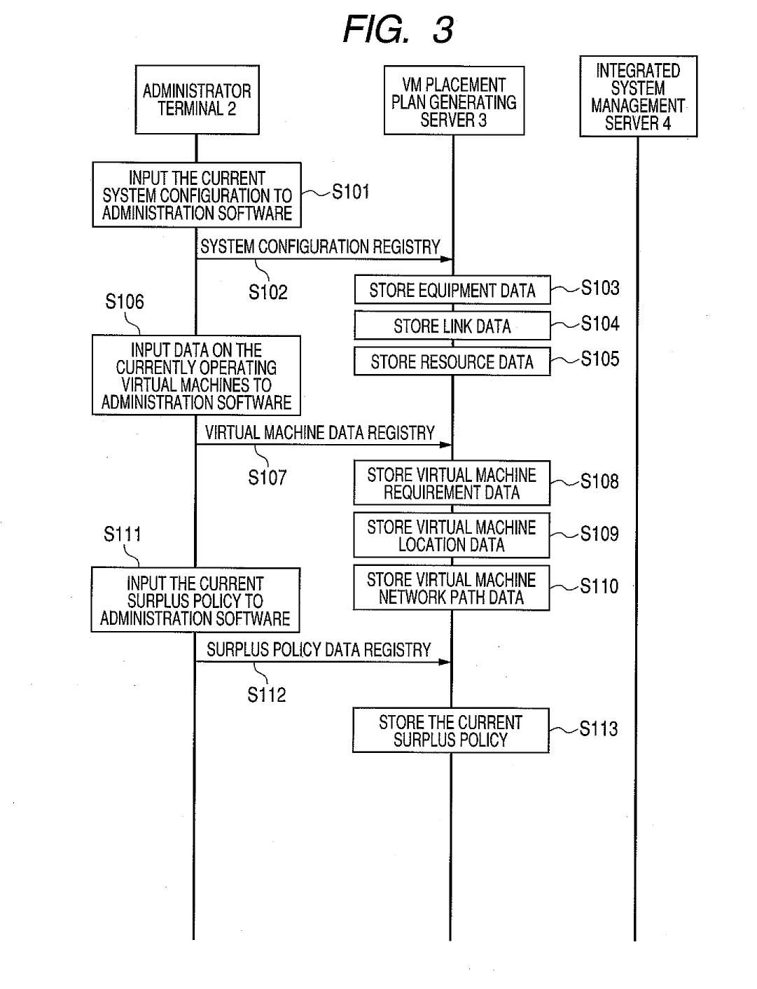

FIGS. 3 to 5 are sequence diagrams illustrating an example of operation starting with data input and terminating upon redeployment of virtual machines in the first embodiment.

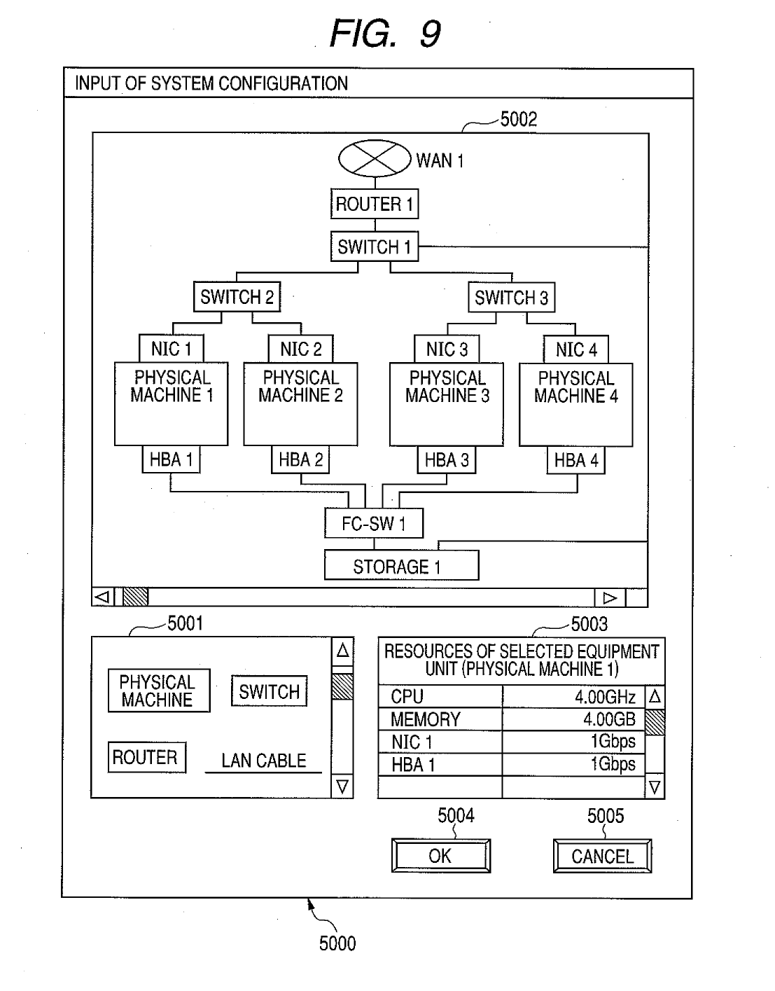

FIG. 3 is a sequence diagram illustrating an example of operation in which the system administrator enters data necessary for a series of processing and FIGS. 9 to 11 show examples of input screens for such data. The data necessary for a series of processing is mainly divided into the following three types:

(1) Data representing the current system configuration
(2) Data on the currently operating virtual machines
(3) Data representing the current surplus policy

First, the system administrator inputs the current system configuration to the administration software (S101).

This system configuration needs to include data regarding the equipment units in the data center system, the connections between the equipment units, and the resources that the equipment units have respectively.

FIG. 9 shows an example of an input screen for system configuration data. Referential numeral 5001 denotes a tool box including elements for presenting a system configuration. Referential numeral 5002 denotes an area for input of a system configuration by assigning and deploying the elements in the tool box. Referential numeral 5003 denotes a section for input of the resources of an equipment unit. Referential numeral 5004 denotes a button for transmitting input information to the VM placement plan generating server and 5005 denotes a button for aborting the input operation.

When the above data have been input, the administration software transmits the system configuration registry to the VM placement plan generating server 3 (S102). The system configuration registry contains the values entered by the system administrator in the step S101.

When the service program 331 at the VM placement plan generating server 3 receives the system configuration registry, the service program 331 stores the data contained in the system configuration registry into the database (S103 to S105).

In the present embodiment, the system administrator enters equipment data, link data, and resource data on a single screen. However, these data may be input on separate screens.

Time and effort taken by the system administrator to enter these data may be reduced by the following means. Initially, the VM placement plan generating server 3 may automatically create part or all of these data, using a protocol for monitoring and controlling communication devices. The protocol for monitoring and controlling communication devices may be, inter alia, SNMP (Simple Network Management Protocol). Alternatively, if these data have already been stored in the database 330 or the database on another server, such data may be used.

Then, the system administrator inputs data on the currently operating virtual machines to the administration software (S106).

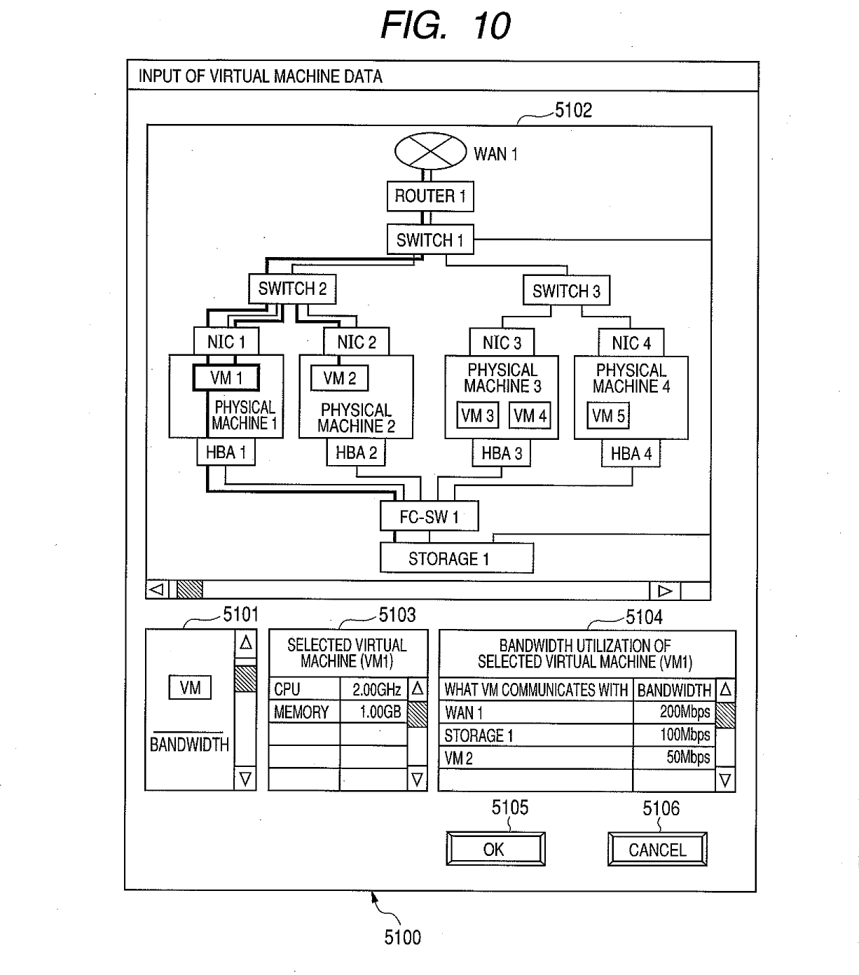

FIG. 10 shows an example of an input screen for entering data on the currently operating virtual machines. Referential numeral 5101 denotes a tool box including elements for presenting a virtual machine and a bandwidth that the virtual machine utilizes. Referential numeral 5102 denotes an area for input of the locations of virtual machines and the network paths through which traffic originated by each virtual machine passes. Referential numeral 5103 denotes a section for input of resources to be assured at minimum for each virtual machine. Referential numeral 5104 denotes a section for input of bandwidth to be assured at minimum for each virtual machine. Referential numeral 5105 denotes a button for transmitting input information to the VM placement plan generating server and 5106 denotes a button for aborting the input operation.

When the above data have been input, the administration software at the administrator terminal 2 transmits the virtual machine data registry to the VM placement plan generating server 3 (5107). The virtual machine data registry contains the values entered by the system administrator in the step S106.

When the service program 331 at the VM placement plan generating server 3 receives the virtual machine data registry, the service program 331 stores the data contained in the virtual machine data registry into the database (S108 to S110).

In the present embodiment, virtual machine requirement data, virtual machine location data, and virtual machine network path data are allowed to be input on a single screen. However, these data may be input on separate screens.

Time and effort taken by the system administrator to enter these data may be reduced by the following means. Initially, the VM placement plan generating server 3 may automatically create part or all of these data, using software that allows for communication with the managerial interfaces of the physical machines 5. A hypervisor distributor provides such software. Alternatively, if these data have already been stored in the database 330 or the database on another server, such data may be used.

Finally, the system administrator inputs data on the current surplus policy, i.e., the first surplus policy to the administration software (S111).

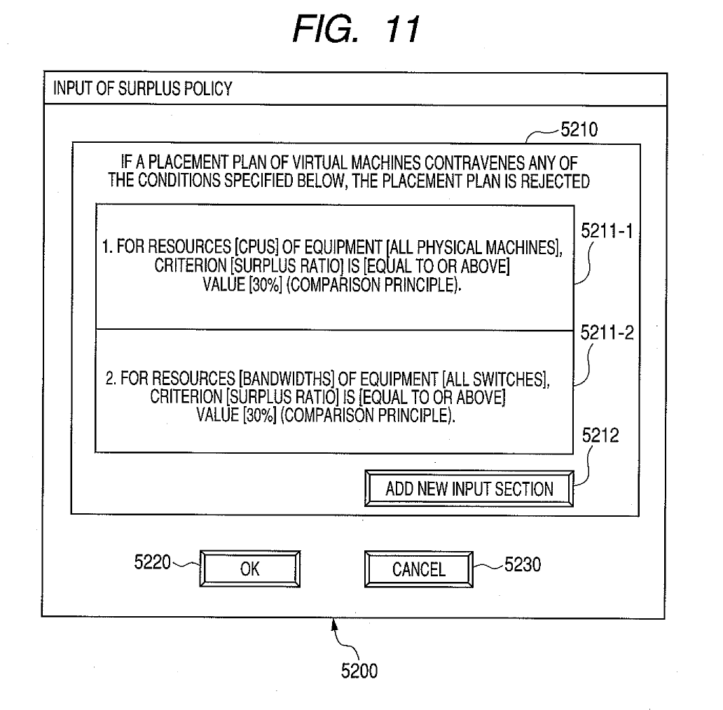

FIG. 11 shows an example of an input screen for data on the current surplus policy. Referential numeral 5211 denotes sections for input of surplus policy items. A surplus policy structure that can be entered is the same as the surplus policy data 1600. Referential numeral 5212 denotes a button for adding a new input section. Although two items of surplus policy are specified in FIG. 11, more than two items of surplus policy can be input by pressing this button. Referential numeral 5220 denotes a button for transmitting input information to the VM placement plan generating server and 5230 denotes a button for aborting the input operation.

When the above data has been input, the administration software transmits the surplus policy data registry to the VM placement plan generating server 3 (S112). The surplus policy data registry contains the values entered by the system administrator in the step S111.

When the service program 331 at the VM placement plan generating server 3 receives the surplus policy data registry, the service program 331 stores the data contained in the surplus policy data registry into the database (S113).

Time and effort taken by the system administrator to enter this data may be reduced by the following means. Initially, if this data has already been stored in the database 330, such data may be used. Alternatively, the VM placement plan generating server 3 may automatically create the current surplus policy, based on the data stored in the steps S103 to S105 and the steps S108 to S110.

An exemplary procedure in which the VM placement plan generating server 3 automatically generates the current surplus policy is described below. Here, it is assumed to create the surplus policy regarding the CPUs of the physical machines. First, the VM placement plan generating server 3 calculates the amount of CPU utilization of each physical machine. For this calculation, equipment data 1000, virtual machine requirement data 1300, and virtual machine location data 1400 are used. Then, the VM placement plan generating server 3 calculates the surplus ratio of the CPU of each physical machine. For this calculation: resource data 1200 is used in addition to the above amount of utilization. At this time, the minimum surplus ratio of the CPU of each physical machine is assumed to be M %. Finally, the above server generates the surplus policy, using the value of M %. For example, it generates the surplus policy that “rejects a deployment contravening the condition that the surplus ratios of the CPUs of all physical machines are equal to or above M %”. The current deployment of virtual machines does not contravene this surplus policy. In a similar manner, of course, it is possible to automatically create a surplus policy with definitions of equipment other than the physical machines, resources other than the CPUs, and criterion other than the surplus ratio.

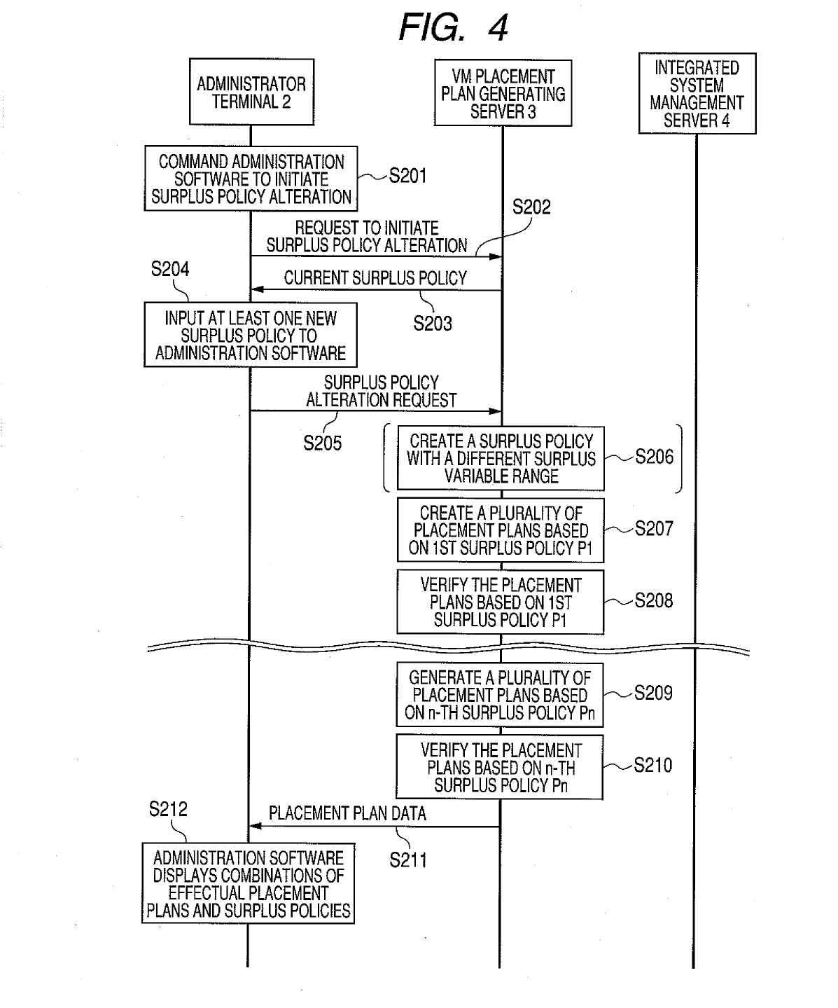

FIG. 4 is a sequence diagram illustrating an example of operation in which the VM placement plan generating server 3 generates placement plans in response to commands of the system administrator.

First, the system administrator commands the administration software to initiate surplus policy alteration (S201). This command is issued by, e.g., pressing a menu button. In response to this command, the administration software transmits a request to initiate surplus policy alteration to the VM placement plan generating server 3 (S202). When the service program 331 at the VM placement plan generating server 3 receives this request, the service program 331 transmits the current surplus policy to the administration software (S203).

Upon receiving the current surplus policy, the administration software displays a screen for surplus policy alteration.

FIG. 12 shows an example of a screen for surplus policy alteration. Referential numeral 5311 denotes sections for displaying the surplus policy items before alteration and 5321 denotes sections for input of altered surplus policy items. A surplus policy structure that can be entered in the sections 5321 is the same as the surplus policy data 1600. In FIG. 12, compartments altered by the system administrator part are highlighted in boldface. In this example, the system administrator alters the surplus policy, intending to decrease the surplus. Referential numeral 5322 denotes a button for adding a new input section. Referential numeral 5330 is a button for adding one more area (which is the same as the area 5320) for another altered surplus policy. In the present system, the system administrator is allowed to enter a plurality of altered surplus policies and request the VM placement plan generating server 3 to create respective placement plans for the surplus policies. Referential numeral 5340 denotes a button for transmitting input information to the VM placement plan generating server and 5350 denotes a button for aborting the input operation.

Using the above screen, the administrator inputs at least one new surplus policy, i.e., the second surplus policy to the administration software (S204). Then, the administration software transmits a surplus policy alteration request for alteration from the first to the second surplus policy to the VM placement plan generating server 3 (S205). This request involves the values entered by the system administrator in the step S204. The service program 331 at the VM placement plan generating server 3 receives this request.

At this time, the service program 331 may pass the new surplus policy to the surplus policy generating program 336 before passing the surplus policy to the placement plan generating program 332. The surplus policy generating program 336 which is a surplus policy generating unit generates at least one new surplus policy, a third surplus policy in which a surplus variable range differs from that in the new surplus policy passed to it, based on a predefined rule (S206). For example, if the surplus ratio for CPUs included in the surplus policy is altered from 30% to 20%, the surplus policy generating program 336 may automatically create a surplus policy with a surplus ratio of 25% and a surplus policy with a surplus ratio of 10% as third surplus policies. Thereby, surplus policies not foreseen by the system administrator and deployments based thereon can be provided to the administrator as recommendations.

When the service program 331 at the VM placement plan generating server 3 receives the surplus policy alteration request, the service program 331 passes one or more surplus policies included in the request to the placement plan generating program 332. If the surplus policy generating program 336 is made use of, at least one new third surplus policy created by this program is also passed to the placement plan generating program 332.

The placement plan generating program 332 generates a plurality of placement plans, based on a plurality of surplus policies passed from the service program 331 (S207, S209).

An exemplary method for generating placement plans is described below.

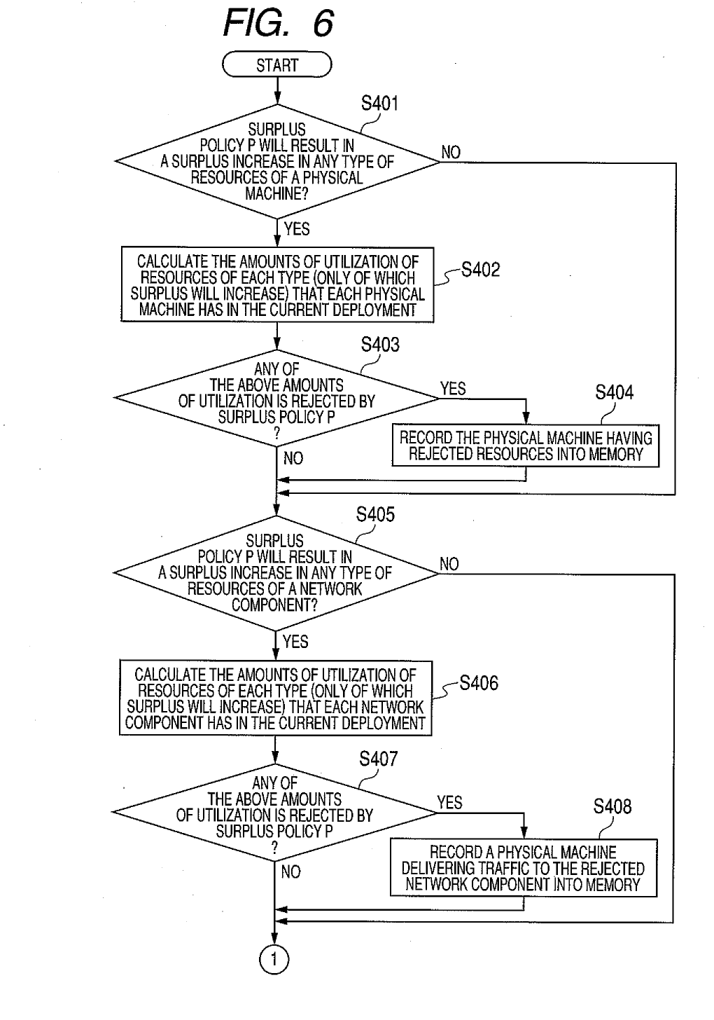

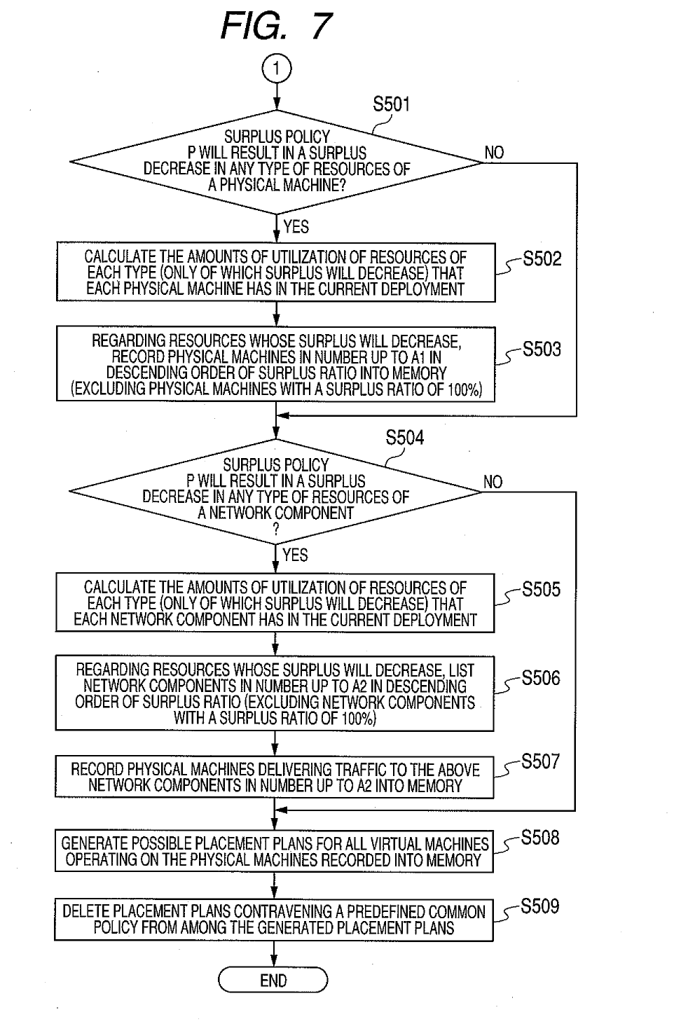

FIG. 6 and FIG. 7 are flowcharts for a process in which the placement plan generating program 332 generates a plurality of placement plans, based on a certain surplus policy P.

First, the placement plan generating program 332 compares the current surplus policy and the surplus policy P and checks whether the surplus policy P will result in a surplus increase in any type of resources of a physical machine (S401).

If there will be a surplus increase in any type of resources, the placement plan generating program 332 calculates the amounts of utilization of resources of each type that each physical machine has in the current deployment of virtual machines (S402). This calculation should be executed for only the resources whose surplus will increase. For this calculation, equipment data 1000, virtual machine requirement data 1300, and virtual machine location data 1400 are used.

Then, the placement plan generating program 332 checks whether any of the amounts of utilization calculated in the step S402 is rejected by the surplus policy P (S403). For this calculation, resource data 1200 is used in addition to the data used in the step S402. If any of the amounts of utilization calculated in the step S402 is rejected by the surplus policy P, the physical machine having the rejected resources is recorded into the memory (S404).

Next, the placement plan generating program 332 compares the current surplus policy and the surplus policy P and checks whether the surplus policy P will result in a surplus increase in any type of resources of a network component (S405).

If there will be a surplus increase in any type of resources, the placement plan generating program 332 calculates the amounts of utilization of resources of each type that each network component has in the current deployment of virtual machines (S406). This calculation should be executed for only the resources whose surplus will increase. For this calculation, equipment data 1000, link data 1100, virtual machine requirement data 1300, virtual machine location data 1400, and virtual machine network path data 1500 are used.

Then, the placement plan generating program 332 checks whether any of the amounts of utilization calculated in the step S406 is rejected by the surplus policy P (S407). For this calculation, resource data 1200 is used in addition to the data used in the step S406. If any of the amounts of utilization calculated in the step S406 is rejected by the surplus policy P, a physical machine delivering traffic to the network component having the rejected resources is recorded into the memory (S408).

By the processing until this point, physical machines that will be particularly affected by the anticipated surplus increase in their resources are listed. In consequence, it is possible to narrow down the number of virtual machines that should be relocated.

Next, the placement plan generating program 332 compares the current surplus policy and the surplus policy P and checks whether the surplus policy P will result in a surplus decrease in any type of resources of a physical machine (S501).

If there will be a surplus decrease in any type of resources, the placement plan generating program 332 calculates the amounts of utilization of resources of each type that each physical machine has in the current deployment of virtual machines (S502). This calculation should be executed for only the resources whose surplus will decrease. For this calculation, equipment data 1000, virtual machine requirement data 1300, and virtual machine location data 1400 are used.

Using the result of the calculation in the step S502, the placement plan generating program 332 then records physical machines in number up to A1 in descending order of surplus ratio into the memory (S503), wherein A1 is a constant preset by the system administrator. For the surplus ratio calculation, resource data 1200 is used in addition to the data used in the step S502. At this time, resources whose surplus ratio is 100% (physical machines on which no virtual machine operations) are excluded from comparison. It is assumed that physical machines with a higher surplus ratio of resources have a fewer number of virtual machines running thereon. Hence, according to this estimation, physical machines are selected. As a result, at step S508, placement plans providing more physical machines with the surplus ratio of 100% (having no virtual machine running thereon) are preferentially created.

Next, the placement plan generating program 332 compares the current surplus policy and the surplus policy P and checks whether the surplus policy P will result in a surplus decrease in any type of resources of a network component (S504).

If there will be a surplus decrease in any type of resources, the placement plan generating program 332 calculates the amounts of utilization of resources of each type that each network component has in the current deployment of virtual machines (S505). This calculation should be executed for only the resources whose surplus will decrease. For this calculation, equipment data 1000, link data 1100, virtual machine requirement data 1300, virtual machine location data 1400, and virtual machine network path data 1500 are used.

Using the result of the calculation in the step S505, the placement plan generating program 332 then lists network components in number up to A2 in descending order of surplus ratio of the resources (S506), wherein A2 is a constant preset by the system administrator. For the surplus ratio calculation, resource data 1200 is used in addition to the data used in the step S505. At this time, resources whose surplus ratio is 100% (not involved in carrying traffic) are excluded from comparison.

Then, physical machines delivering traffic to the above network components in number up to A2 are recorded into the memory (S507). It is estimated that only a fewer number of virtual machines deliver traffic to network components with a higher surplus ratio of resources. Hence, according to this estimation, physical machines are selected. As a result, at step S508, placement plans providing more network components with the surplus ratio of 100% (not involved in carrying traffic) are preferentially created.

The above description in the previous paragraphs concerns preprocessing for generating placement plans.

Four phases (S401 to S404, S405 to S408, S501 to S503, and S504 to S507) of preprocessing are described above. However, the placement plan generating program 332 does not always need to perform all these phases.

The placement plan generating program 332 lists all virtual machines running on the physical machines recorded as above and generates possible placement plans for relocating these virtual machines (S508). The number of these placement plans becomes fewer than the number of possible placement plans for relocating all virtual machines. Therefore, the above-described method allows for a validation process by the placement plan verification program 333 to be done in a shorter time than ever before. When thus generating possible placement plans (S508), virtual machines to be relocated are selected as follows. For example, if there will be a surplus increase in resources, virtual machines on equipment units such as physical machines having rejected resources should be relocated from the equipment units having the rejected resources. Alternatively, if there will be a surplus decrease in resources, virtual machines on equipment units utilizing a smaller amount of resources should be relocated from the equipment units.

Subsequently, the placement plan generating program 332 deletes placement plans contravening a predefined common policy from among the created placement plans (S509). The common policy is independent of surplus policy alteration that is preconfigured by the system administrator. The common policy includes, e.g., “rejecting a deployment in which 10 or more virtual machines run on one physical machine” and “rejecting a deployment in which 10 or more virtual machines are relocated as compared with the current locations of virtual machines”.

The foregoing is an example of operation of the placement plan generating program 332.

In the present example, the processing by the placement plan generating program 332 branches according to a direction of surplus change (increase or decrease). However, the processing may branch according to a surplus variable range (e.g., a variable range of surplus ratio) in addition to a direction of surplus change. If, for example, surplus policy alteration is made to result in an additional surplus of 20% in CPU resources, it is also possible create only placement plans to relocate virtual machines having a CPU utilization ratio approximate to the surplus of 20%. In this case, the number of placement plans can be made fewer than in the above-described embodiment.

The placement plan generating program 332 passes created placement plans to the placement plan verification program 333. The placement plan verification program 333 validates the placement, plans, based on the surplus policy P (S208, S210).

An exemplary method for validating placement plans is described below.

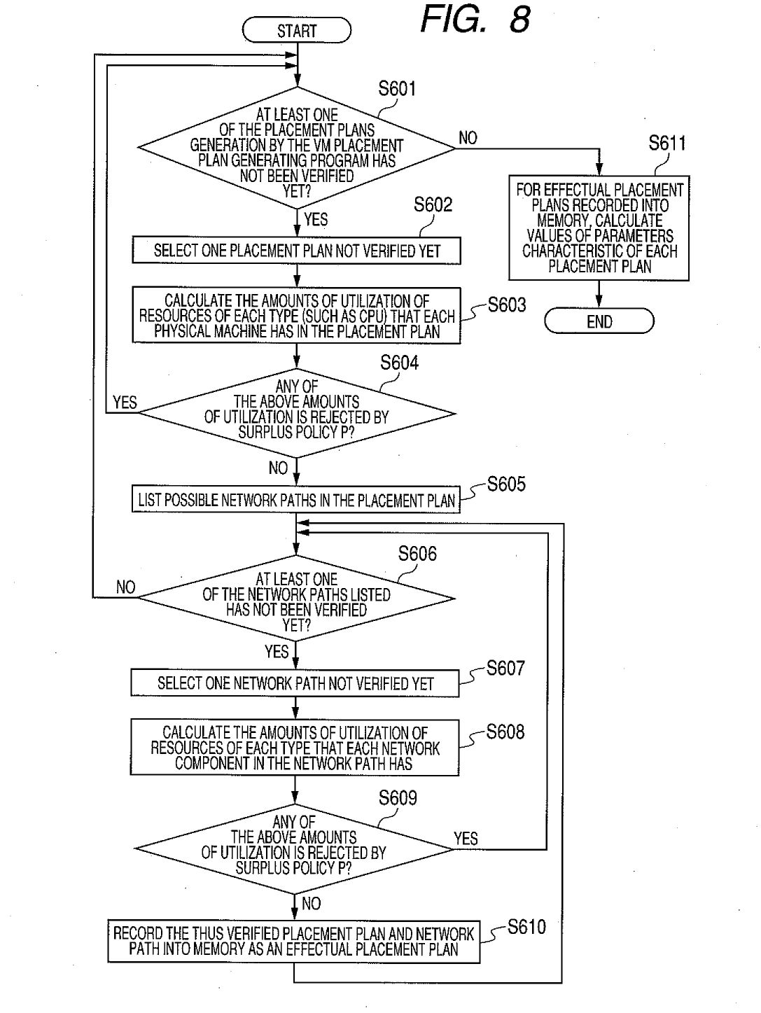

FIG. 8 is a flowchart for a process in which the placement plan verification program 333 validates a plurality of placement plans, based on a surplus policy P.

First, the placement plan verification program 333 checks whether at least one of the placement plans created by the placement plan generating program 332 has not been validated yet (S601).

If one or more placement plans have not been validated yet, the placement plan verification program 333 selects one placement plan not validated yet from those (S602). Then, it calculates the amounts of utilization of resources of each type that each physical machine has in the placement plan (S603). For this calculation, equipment data 1000 and virtual machine requirement data 1300 are used in addition to the placement plan data.

Then, the placement plan verification program 333 checks whether any of the amounts of utilization calculated in the step S603 is rejected by the surplus policy P (S604). For this calculation, resource data 1200 is used in addition to the data used in the step S603.

If any of the amounts of utilization calculated in the step S603 is rejected by the surplus policy P, the program discards the placement plan under validation and returns to the step S601. If not, the program proceeds to further validation in step S605 and subsequent.

The placement plan verification program 333 lists all possible network paths in the placement plan (S605). In most cases, one network path is defined with respect to one location. However, for example, if a physical machine is equipped with a plurality of NICs which are respectively connected to different switches, a plurality of network paths may be defined with respect to one location.

Next, the placement plan verification program 333 checks whether at least one of the network paths listed in the step S605 has not been validated yet (S606).

If there are no network paths not validated yet, the program discards the placement plan under validation and returns to the step S601. If not, the program proceeds to further validation in step S607 and subsequent.

The placement plan verification program 333 selects one of the network paths listed in the step S605 (S607). Then, it calculates the amounts of utilization of resources of each type that each network component in the path has in the placement plan (S608). For this calculation, in addition to the placement plan, equipment data 1000, link data 1100, virtual machine requirement data 1300, virtual machine location data 1400, and virtual machine network path data 1500 are used.

Then, the placement plan verification program 333 checks whether any of the amounts of utilization calculated in the step S608 is rejected by the surplus policy P (S609). For this calculation, resource data 1200 is used in addition to the data used in the step S608.

If any of the amounts of utilization calculated in the step S608 is rejected by the surplus policy P, the program discards the network path under validation and returns to the step S606. If not so, the program records a combination of the thus validated placement plan and network path into the memory as an effectual placement plan (S610) and returns to the step S606.

Upon the completion of validating all placement plans and associated network paths, the placement plan verification program 333 calculates values of parameters characteristic of each placement plan (S611). To help the system administrator in comparing a plurality of placement plans easily, the administration software uses such parameters for reordering the placement plans. Examples of these parameters are given below:

(1) Number of working equipment units (such as physical machines and network components)
(2) Number of ports of working network components
(3) Number of virtual machines to be relocated from their current locations
(4) Size of surplus change (e.g., variable range of surplus ratio) in a surplus policy (1)

In a case where the system administrator wants to reduce overall power consumption of the data center system, the administrator may compare the placement plans, giving priority to the parameters (1) and (2). A scheme in which the parameter (1) is set to a smaller value has an advantage that power consumption can be reduced by deactivating equipment units that need not be worked. A scheme in which the parameter (2) is set to a smaller value has an advantage that power consumption can be reduced by deactivating ports that need not be worked.

In a case where the system administrator wants to complete reconfiguration with as simple procedure as possible, the administrator may compare the placement plans, giving priority to the parameter (3). A scheme in which the parameter (3) is set to a smaller value has an advantage that it takes a shorter time to redeploy virtual machines.

In a case where the system administrator doesnt not want to make a steep surplus change from the current surplus policy, the administrator may compare the placement plans, giving priority to the parameter (4). For instance, assume that placement plan 1 changing the surplus ratio of CPU from the current ratio of 10% to 30% and placement plan 2 changing the current ratio of 10% to 20% are presented. If the parameters (1) and (2) are set to same values in both placement plans, the system administrator may preferentially select placement plan 2 which is approximate to the current surplus policy.

It is also possible to register data to be used for this calculation into the database 330 beforehand and calculate a value of an additional parameter other the above parameters (1) to (4). For example, power consumptions of all equipment units may be registered into the database 330 beforehand and the overall power consumption of the data center system in each placement plan may be calculated.

The foregoing is an example of operation of the placement plan verification program 333.

The VM placement plan generating server 3 repeats the processes of the placement plan generating program 332 and the placement plan verification program 333 as many times as the number of surplus policies specified by the system administrator. However, the server may quit repeating these processes in the middle when the number of placement plans that passed validation has exceeded a threshold. In that case, the administration software represents ordering of the surplus policies in terms of “priority” and needs to explicitly indicate that a surplus policy of a lower priority is not likely to be used.

After the validation of the placement plans, the service program 331 transmits placement plan data to the administration software (S211). This placement plan data includes combinations of effectual placement plans and surplus policies and values for reordering of the placement plans.

Upon receiving the placement plan data the administration software displays combinations of effectual placement plans and surplus policies on a screen (S212).

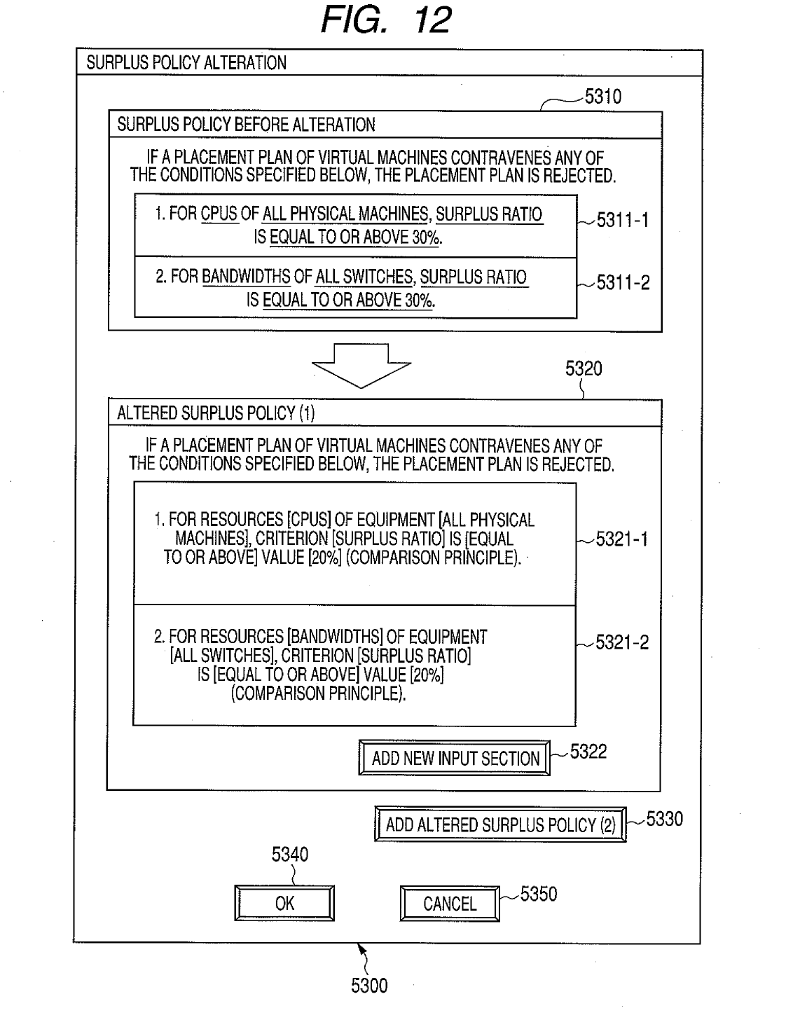

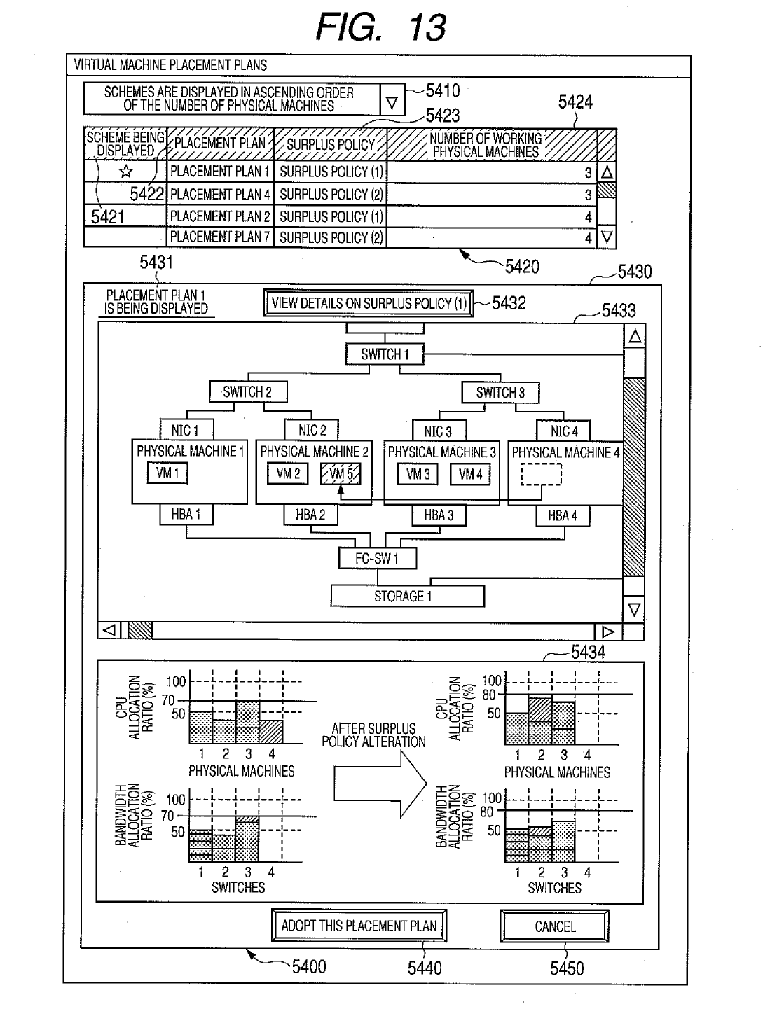

FIG. 13 shows an example of a screen for displaying a combination of a placement plan and a surplus policy. Referential numeral 5410 denotes a field for selecting a criterion of reordering the placement plans. Referential numeral 5420 denotes a table listing combinations of placement plans and surplus policies. Referential numeral 5421 denotes a column for selecting a placement plan to be displayed in an area 5430, 5422 denotes a column for placement plans, 5423 denotes a column for surplus policies, and 5424 denotes a column for a value used for reordering. Reference numeral 5430 denotes an area where data on the currently selected placement plan is displayed. Reference numeral 5431 denotes the name of the currently selected placement plan. Reference numeral 5432 denotes a button for display details on a surplus policy used for generating the placement plan in another window. Reference numeral 5433 denotes a section for showing virtual machine relocation due to adoption of the placement plan. Reference numeral 5434 denotes a section for showing surplus changes of each type of resources due to adoption of the placement plan. Reference numeral 5440 is a button to command the W4 placement plan generating server to adopt the placement plan being displayed in the area 5430. Reference numeral 5450 denotes a button for aborting virtual machine redeployment.

Although one criterion of reordering is only used in FIG. 13, the administration software may use a combination of a plurality of criteria of reordering. For example, criteria of reordering may be defined as follows: a top-priority criterion “in ascending order of the number of working physical machines”; a second-priority criterion “in ascending order of the number of virtual machines to be relocated from their current locations”; and a third-priority criterion “in ascending order of surplus change in the surplus policy”. The reordering may be performed based on these criteria.

As the administration software displays the data as above, the system administrator can select a placement plan and its associated surplus policy which are optimum for the demand of the administrator. As the demand of the system administrator, the administrator may want to reduce the number of working physical machines, reduce the number of virtual machines to be relocated from their current locations, that is, the number of virtual machines that need to be relocated, or keep the surplus change as small as possible in the surplus policy.

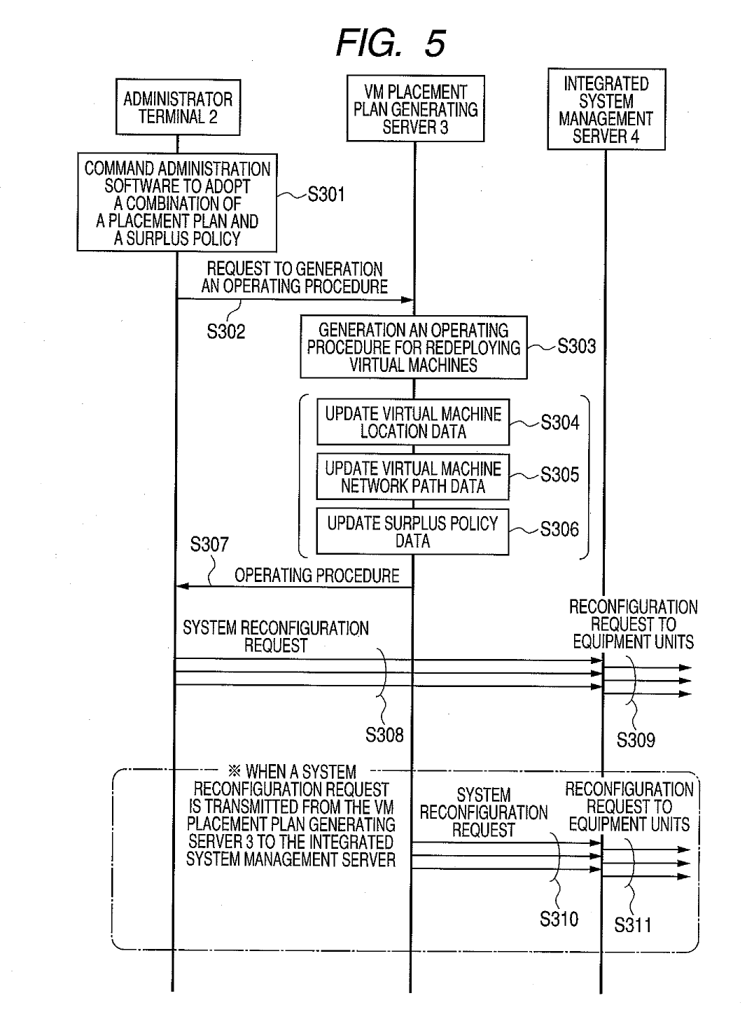

FIG. 5 is a sequence diagram illustrating an example of operation in which the VM placement plan generating server 3 generates a system reconfiguration procedure in response to a command of the system administrator.

First, the system administrator commands the administration software to adopt a combination of a placement plan and a surplus policy (S301). This command is issued through the screen as shown in FIG. 13. In response to this command, the administration software transmits a request to create an operating procedure to the VM placement plan generating server 3 (S302). This request includes the placement plan data selected by the system administrator and the surplus policy data used for generating the placement plan.

When the service program 331 at the VM placement plan generating server 3 receives this request, the service program 331 passes the placement plan data to the operation procedure generating program 334. The operation procedure generating program 334 generates an operating procedure for redeploying virtual machines, using the placement plan data, equipment data 1000, link data 1100, virtual machine location data 1400, and virtual machine network path data 1500 (S303). This operating procedure includes a plurality of procedures for relocating virtual machines, configuring virtual networks of network components (configuring VLANs), among others.

The service program 331 transmits this operating procedure to the administration software (S307). At this time, the service program 331 may update virtual machine location data 1400, virtual machine network path data 1500, and surplus policy data 1600, using the data included in the request to create an operating procedure (5304 to 5306). By updating these data, it is possible to reduce time and effort taken by the system administrator to enter these data, next time the surplus policy is altered.

When the administration software at the administrator, terminal 2 receives the operating procedure, the administration software transmits a system reconfiguration request to the integrated system management server 4 (S308). This system reconfiguration request includes commands for relocating virtual machines, reconfiguring virtual networks of network components, among others. The administration software needs to have a correlation table of procedures and commands. The integrated system management server 4 performs reconfiguration of the equipment units according to these commands (S309).

Although a system reconfiguration request is transmitted from the administration software to the integrated system management server 4 in FIG. 5, this request may be transmitted from the VM placement plan generating server 3 to the integrated system management server 4. In that case, the operation procedure generating program 334 passes the created operating procedure to the operation procedure performing program 335. The operation procedure performing program 335 transmits a system reconfiguration request to the integrated system management server 4 (S310). The operation procedure performing program 335 needs to have a correlation table of procedures and commands. The integrated system management server 4 performs reconfiguration of the equipment units according to these commands (S311).

Although the system administrator selects a combination of a placement plan and a surplus policy to be adopted in the step S301 in the present embodiment, the VM placement plan generating server 3 may make this selection automatically. In that case, the system administrator first registers a criterion for automatic selection of a placement plan to be adopted to the VM placement plan generating server 3. As the criterion, the values calculated in the step S611 can be used. For example, the criterion may be to select a placement plan in which the number of working physical machines is smallest. In turn, the VM placement plan generating server 3 selects a combination of a placement plan and a surplus policy to be adopted, based on the above criterion, instead of transmitting placement plan data to the administration software in the step S211. Then, the program generates an operating procedure for redeploying virtual machines (as in the step S303). In this way, a part of the work to be done by the system administrator can be simplified.

The foregoing is an example of the procedure for redeploying virtual machines based on surplus policy alteration.

In the way described above, the VM placement plan generating server 3 can present a plurality of placement plans to the system administrator, based on the surplus policy input by the system administrator. This allows the system administrator to alter surplus resources in the data center system more easily than ever before. In other words, the system administrator can alter surplus resources more frequently than ever before. A resulting effect is that the data center system can realize a deployment in which a balance is achieved between avoiding a performance-related problem and providing the required number of working equipment units.

Further, when validating placement plans, the VM placement plan generating server 3 takes both the resources of physical machines and the resources of network components into account. This produces an effect that can reduce the possibility that a new performance-related problem may arise by virtual machine relocation by the system administrator.

Further, based on the data created by the VM placement plan generating server 3, the administration software displays surplus changes in the resources of each type in a new placement plan and the characteristics of the new placement plan to the system administrator. The system administrator can compare different placement plans, based on the thus displayed data. This produces an effect that the system administrator can select a placement plan that most suits the aim of the administrator out of a plurality of placement plans created by the VM placement plan generating server 3.

Further, the VM placement plan generating server 3 compares the current surplus policy and a new surplus policy and generates placement plans, based on a direction of surplus change (increase or decrease) in the resources or the amount of the change. This produces an effect that the number of created placement plans can be limited, as compared with a case where the VM placement plan generating server 3 generates all possible placement plans of virtual machines. A resulting effect is that it is possible to shorten the calculation time taken to create the placement plans and validate them.

Further, the VM placement plan generating server 3 compares the current surplus policy and the new surplus policy input by the system administrator and is able to automatically create a different surplus policy not input by the system administrator. This produces an effect that the VM placement plan generating server 3 can create a surplus policy not foreseen by the system administrator and a set of placement plans based on the surplus policy. A resulting effect is that the system administrator can find a more desirable surplus policy.

### Second Embodiment

In the foregoing first embodiment, one example of the VM placement plan generating server was discussed, wherein the server generates placement plans, based on one or more surplus policies. In the second embodiment, another example of the VM placement plan generating server is discussed, wherein the server generates placement plans, while adjusting a surplus policy repeatedly, based on results of validation of placement plans.

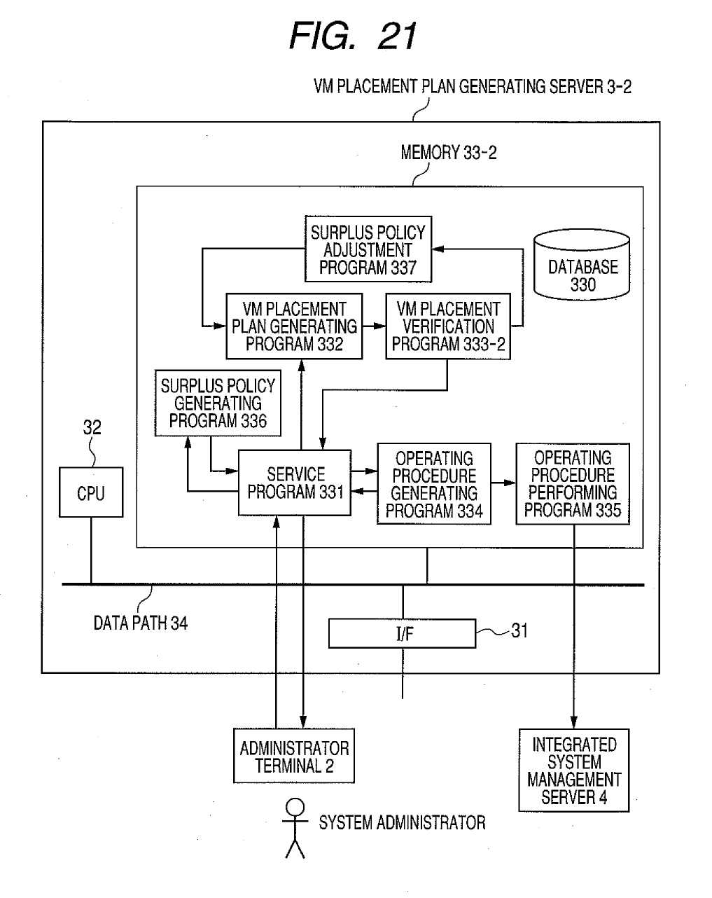

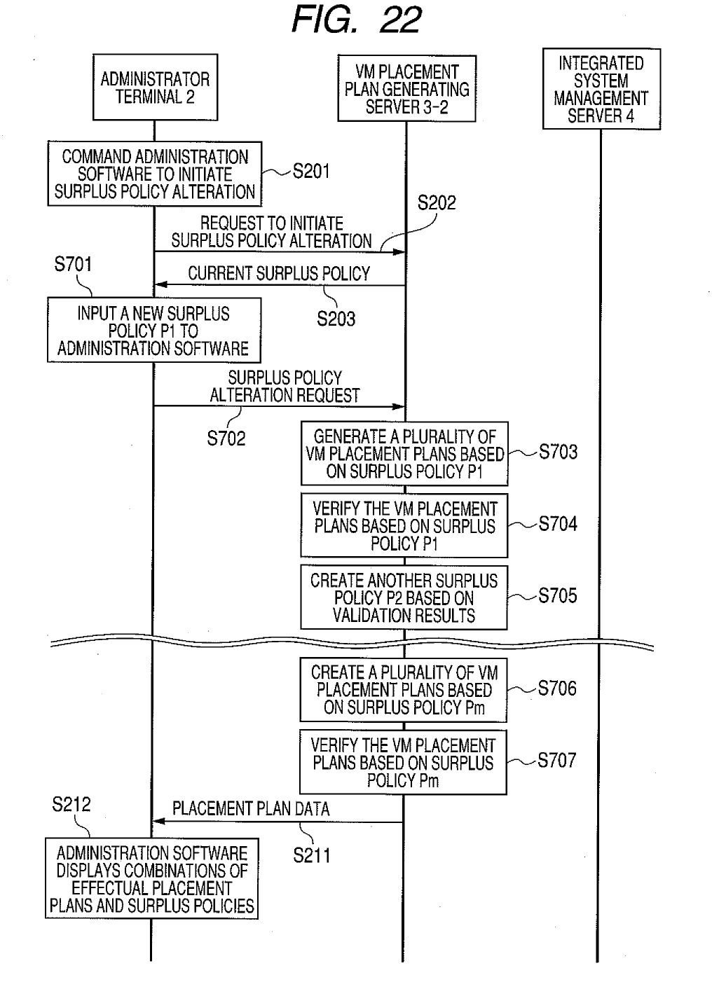

FIG. 21 is a functional block diagram showing an internal structure of a VM placement plan generating server 3-2 pertaining to the second embodiment. Difference from the first embodiment lies in that the memory 33-2 stores a surplus policy adjusting program 337. Along with the addition of the surplus policy adjusting program 337, some processes are added to the placement plan verification program 333-2, as will be described below. Others are the same as in the first embodiment. So, their explanation is skipped in this second embodiment section.

The surplus policy adjusting program 337 is a program to create a new surplus policy, based on results of validation by the placement plan verification program 333-2. The surplus policy adjusting program 337 generates a new surplus policy by adjusting a value such as a surplus ratio included in a surplus policy validated by the placement plan verification program 333-2.

The placement plan verification program 333-2 records validation results into the memory for use by the surplus policy adjusting program 337.

The operation phase in which the system administrator inputs data necessary for a series of processing is the same as in the first embodiment. So, description thereof is skipped in this second embodiment section.

FIG. 22 is a sequence diagram illustrating an example of operation in which the VM placement plan generating server 3-2 generates placement plans in response to commands of the system administrator. In the following description, points that differ from the first embodiment will only be described in detail.

Steps S201 to S203 are the same as in the first embodiment. So, description thereof is skipped in this second embodiment section.

Then, the system administrator inputs a new surplus policy P1 via the same screen (FIG. 12) as in the first embodiment (701). In the present embodiment, to simplify explanation, the system administrator is assumed to have entered one surplus policy only. If the system administrator has entered a plurality of surplus policies, the VM placement plan generating server 3 executes a series of steps S703 to S707 which will be described below as many times as the number of surplus policies.

Next, the administration software transmits a surplus policy alteration request to the VM placement plan generating server 3-2 (S702). This request includes the values entered by the system administrator in the step S701. The service program 331 at the VM placement plan generating server 3-2 receives this request.

When the service program 331 at the VM placement plan generating server 3-2 receives the surplus policy alteration request, the service program 331 passes the surplus policy P1 included in this request to the placement plan generating program 332. The placement plan generating program 332 generates a plurality of placement plans, based on the surplus policy P1 (S703).

The flowchart of the placement plan generating program 332 is the same as in the first embodiment. So, description thereof is skipped in this second embodiment section.

The placement plan generating program 332 passes the generated placement plans to the placement plan verification program 333-2. The placement plan verification program 333-2 validates the placement plans, based on the surplus policy (5704).

An exemplary method for validating the placement plans is described below.

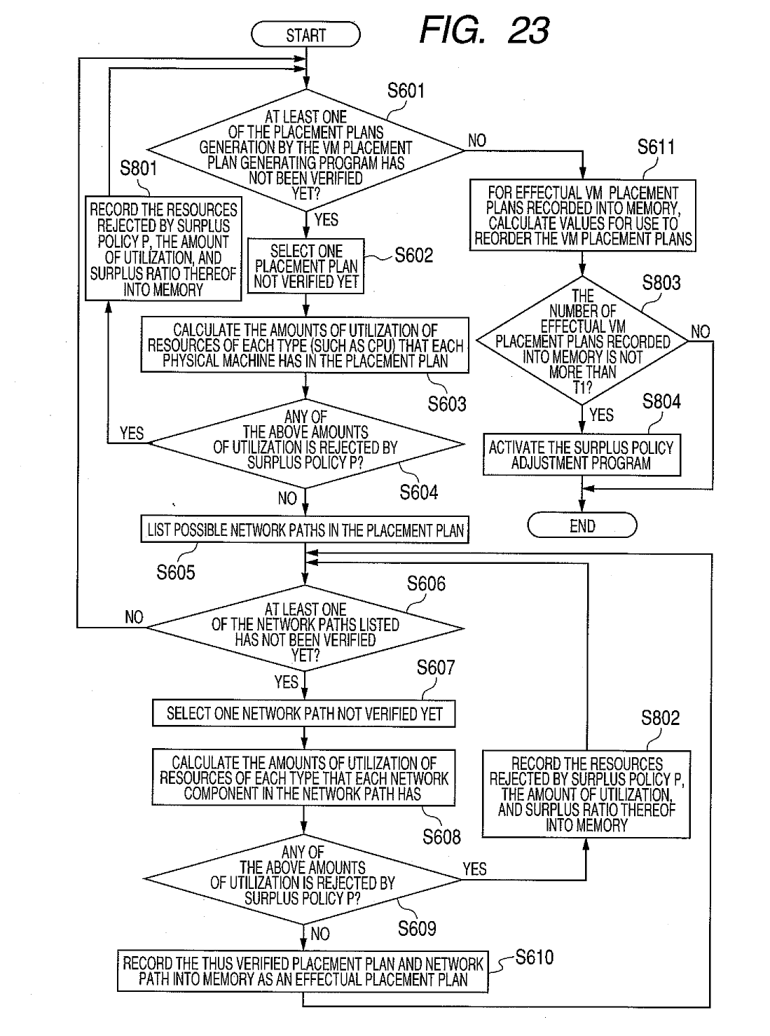

FIG. 23 is a flowchart of a process in which the placement plan verification program 333-2 validates a plurality of placement plans, based on a surplus policy P. In the figure, the same steps as in the flowchart for the corresponding process in the first embodiment are assigned the same numbers as in FIG. 8.

Points that differ from the first embodiment are described below.

Firstly, if any of the amounts of utilization calculated in the step S603 is rejected by the surplus policy P, the placement plan verification program 333-2 records the resources rejected by the surplus policy P, the amount of utilization thereof, and the surplus ratio thereof into the memory as a validation result (S801).

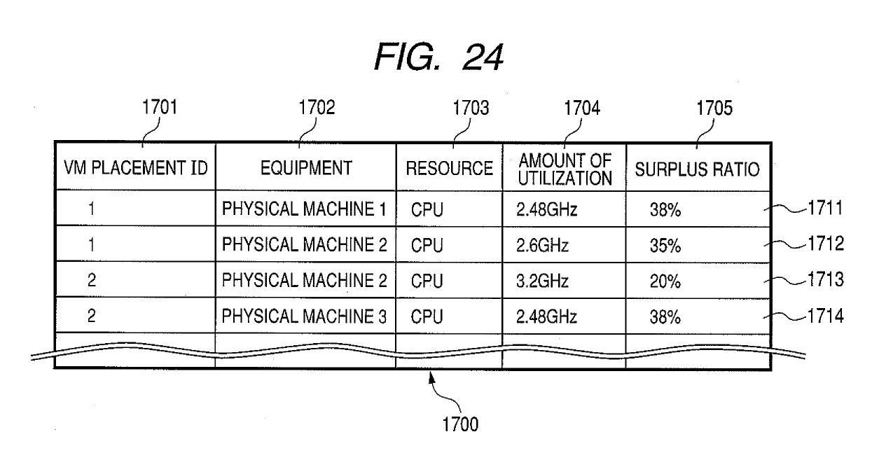

FIG. 24 shows exemplary validation results. Referential numeral 1701 denotes a column for placement plan ID. The VM placement plan generating server 3-2 uniquely assigns ID to each placement plan internally. A column 1702 is for the name of an equipment unit having the resources rejected by the surplus policy P. A column 1703 is for the type of the resources rejected by the surplus policy P. A column 1704 is for the amount of utilization of the resources in the placement plan designated by the placement plan ID. A column 1705 is for the surplus ratio of the resources in the placement plan designated by the placement plan ID.

Secondly, if any of the amounts of utilization calculated in the step S608 is rejected by the surplus policy P, the placement plan verification program 333-2 records the resources rejected by the surplus policy P, the amount of utilization thereof, and the surplus ratio thereof into the memory as a validation result (S802).

Finally, after the step S611, the placement plan verification program 333-2 checks whether the number of effectual placement plans recorded into the memory is not more than a predetermined threshold T1 (S803). If the number of effectual placement plans is not less than the threshold T1, it activates the surplus policy adjusting program 337 (S804).

At this time, as the criterion for determining whether to activate the surplus policy adjusting program 3371, data other than the number of effectual placement plans may be used.

For example, the validating program may compare the number of currently working physical machines with the number of working physical machines in each of the effectual placement plans. Then, it may check whether the number of placement plans resulting in a decrease in the number of working physical machines is not more than a predetermined threshold T2. In this case, it is possible to adjust the surplus policy repeatedly until obtaining a given number of placement plans that can improve the efficiency of assignment of virtual machines to physical machines. Such processing is also possible for network components and their ports instead of physical machines.

The foregoing is an example of operation of the placement plan verification program 333-2 in the second embodiment.

The surplus policy, adjusting program 337 adjusts the value of the surplus policy P1, based on the validation results recorded into the memory by the placement plan verification program 333-2 and generates at least one further surplus policy.

An exemplary method for adjusting the surplus policy is described below.

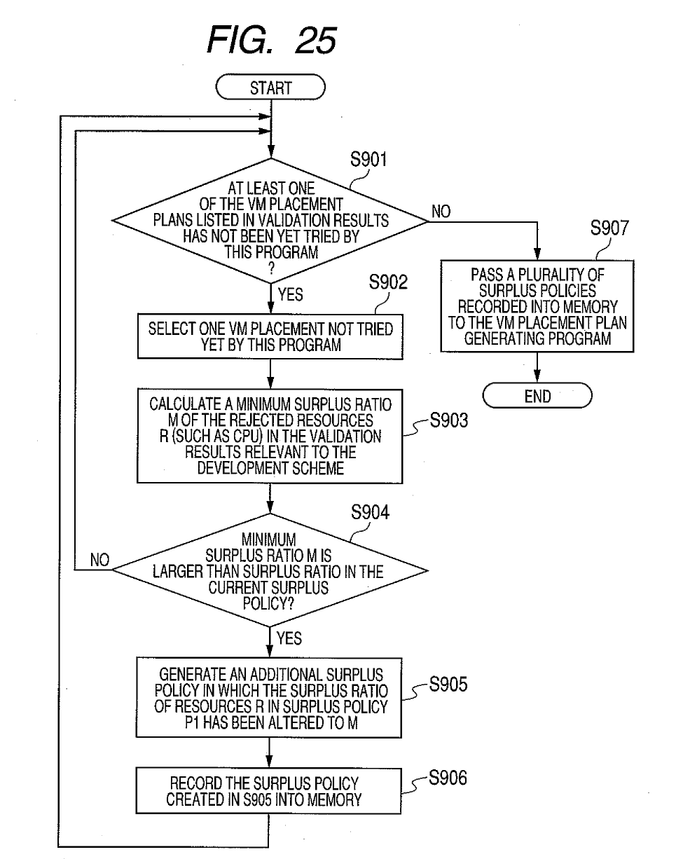

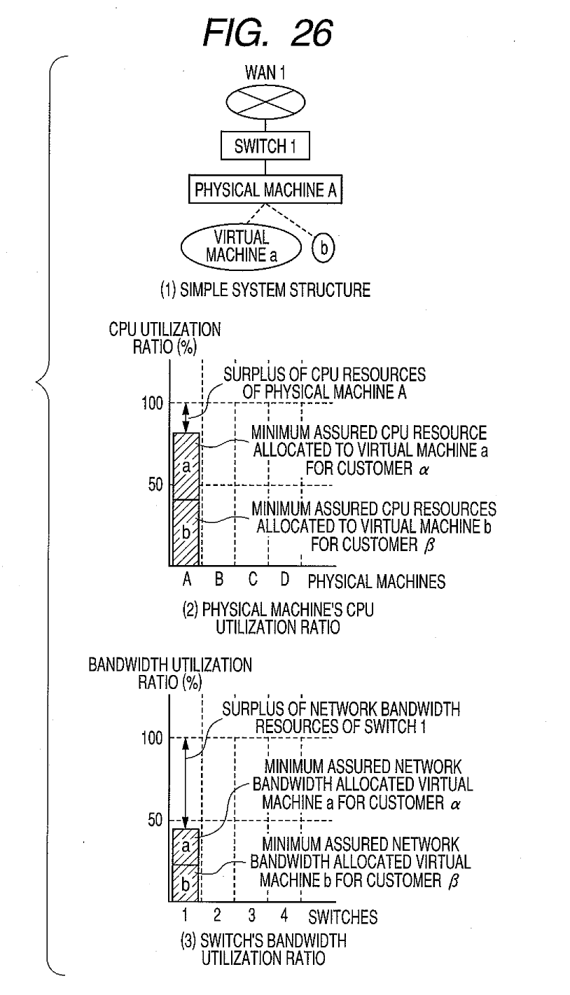

FIG. 25 is a flowchart for a process in which the surplus policy adjusting program 337 adjusts the value of the surplus policy P1 and crease a further surplus policy. In the following, it is assumed that the input specified by the system administrator is to alter the current first surplus policy in which the CPU surplus ratio is 30% to a second surplus policy P1 in which the CPU surplus ratio is 40%. It is also assumed that validation results exemplified in FIG. 24, resulted from the steps S207 and S208, have been recorded into the memory.

First, the surplus policy adjusting program 337 checks whether at least one of the placement plans listed in the above validation results has not been tried yet by this program (S901).

If one or more placement plans have not been tried yet, the surplus policy adjusting program 337 selects one placement plan not tried yet from those (S902). Then, the program calculates a minimum surplus ratio M of the rejected resources R in the validation results relevant to the development scheme (S903). For example, if this program selected placement plan 1, the minimum surplus ratio of the resources R (i.e., CPU) would be found to be 35% from rows 1711 and 1712 of the table in FIG. 24. Otherwise, if this program selected placement plan 2, the minimum surplus ratio of the resources R would be found to be 20% from rows 1713 and 1714 of the table in FIG. 24.

Then, the surplus policy adjusting program 337 checks whether the minimum surplus ratio M calculated in the step S903 is larger than the surplus ratio in current surplus policy (5904). If the minimum surplus ratio M is equal to or smaller than the surplus ratio in current surplus policy, the program returns to the step S901. If not, the program proceeds to step S905. The surplus policy adjusting program 337 generates a further surplus policy in which the surplus ratio of the resources R in the surplus policy P1 has been altered to M and records this surplus policy into the memory (S905, S906).

For example, if this program selected placement plan 1, a third surplus policy P2 exemplified below would be generated.

Surplus policy P2: it rejects any deployment contravening the condition that “the surplus ratios of the CPUs of all physical machines are equal to or above 35%”.

Meanwhile, if this program selected placement plan 2, the program would return to the step S901, generating no surplus policy. If the program creates a surplus policy, using the minimum surplus ratio of 20% for placement plan 2, another surplus policy P3 exemplified below would be generated.

Surplus policy P3: it rejects any deployment contravening the condition that “the surplus ratios of the CPUs of all physical machines are equal to or above 20%”.

However, because the system administrator intended to increase the surplus ratio of CPU in this example, the above surplus policy P3 is against the aim of the system administrator. Hence, the surplus policy adjusting program 337 avoids generating such surplus policy P3 by the check in the step S904.

Upon the completion of processing for all validation results, the surplus policy adjusting program 337 passes a plurality of surplus policies recorded into the memory to the placement plan generating program (S907).

The foregoing is an example of operation of the surplus policy adjusting program 337.

The above-described method is the adjusting method applied in the case that the system administrator intended to increase the surplus ratio. If the system administrator intended to decrease the surplus ratio, another adjusting method would be needed. As an example of such method, the adjusting method may create a surplus policy with a different surplus variable range, using the current surplus policy and the surplus policy P1. In this case, the surplus policy adjusting program 337 performs the same processing as the surplus policy generating program 336.

In the way described above, the VM placement plan generating server 3-2 in the present embodiment is able to adjust the surplus policy repeatedly until a sufficient number of effectual placement plans can be created. Accordingly, even when the system administrator specifies the same number of surplus policies as specified in the first-embodiment procedure, the VM placement plan generating server 3-2 is able to create more placement plans than in the first-embodiment procedure. This produces an effect that it is possible to increase the number of placement plans selectable by the system administrator without increasing the amount of data that the system administrator has to input.

Further, the VM placement plan generating server 3-2 adjusts the surplus policy, based on results of validation of placement plans. In other words, even if the system administrator has specified an improper surplus policy, the VM placement plan generating server 3-2 generates a proper surplus policy on behalf of the system administrator. This produces an effect that the system administrator can find a more desirable surplus policy.

While different embodiments of the present invention have been described hereinbefore with reference to the drawings, actual system architecture is not limited to those embodiments and covers designs and the like without departing from the gist of the invention. It goes without saying that the present invention can also be applied to deploying application programs on operating systems (OS) in physical machines, besides deploying virtual machines in a system having virtualized server resources, network resources, and the like.

What is claimed:

1. A surplus resource management system, management of resources of equipment units connected via a network being performed by a server,
wherein said server includes a placement plan generating unit that generates placement plans for virtual machines which are provided by utilizing the resources, based on a difference between a first surplus policy regarding a current surplus in the resources and a second surplus policy regarding a new surplus in the resources.

2. The surplus resource management system according to claim 1,
wherein said server includes a placement plan validating unit that validates whether each of the created placement plans for virtual machines is rejected by the second surplus policy.

3. The surplus resource management system according to claim 1,
wherein the surplus policy is defined relative to a criterion that is specified as a proportion of surplus resources to a maximum amount of the resources (hereinafter referred to as a surplus ratio), an absolute amount of surplus in the resources, a difference between the surplus ratios of the resources of different equipment units, or a combination thereof.

4. The surplus resource management system according to claim 1,
wherein, if the second surplus policy results in a surplus increase in the resources, said placement plan generating unit sets a virtual machine utilizing an equipment unit having the resources rejected by the second surplus policy to be relocated from the equipment unit; if the second surplus policy results in a surplus decrease in the resources, said placement plan generating unit sets a virtual machine utilizing an equipment unit that utilizes a smaller amount of resources to be relocated from the equipment unit.

5. The surplus resource management system according to claim 2,
wherein said placement plan validating unit validates whether each of the resources included in the created placement plans for virtual machines are rejected by the second surplus policy.

6. The surplus resource management system according to claim 2,
wherein said placement plan validating unit calculates values of parameters characteristic of each of the validated placement plans.

7. The surplus resource management system according to claim 6,
wherein said placement plan validating unit calculates the number of the working equipment units, the number of the virtual machines to be newly-relocated, the number of ports of network components included in the working equipment units, size of surplus change in the surplus policy, or size of surplus in each of the resources, as the parameters characteristic of each of the validated placement plans.

8. The surplus resource management system according to claim 1,
wherein said server includes:
a placement plan validating unit that validates whether each of the created placement plans is rejected by the second surplus policy; and
a surplus policy adjusting unit that adjusts a value included in the second surplus policy used to create the placement plans, based on results of validation by said placement plan validating unit, and generates a further surplus policy.

9. The surplus resource management system according to claim 8,
wherein said surplus policy adjusting unit generates a surplus policy that does not reject at least one of the placement plans rejected by the placement plan validating unit as the further surplus policy.

10. The surplus resource management system according to claim 1, further comprising:
an administrator terminal
wherein said administrator terminal displays combinations of the placement plans created by said placement plan generating unit of said server and the second surplus policy used to create the placement plans.

11. A surplus resource management method, management of resources of equipment units connected via a network being performed by a server,
wherein said server generates at least one placement plan for virtual machines which are provided by utilizing the resources, based on a difference between a first surplus policy regarding a current surplus in the resources and a second surplus policy regarding a new surplus in the resources, and
validates whether each of the created placement plan for virtual machines is rejected by the second surplus policy.

12. The surplus resource management method according to claim 11,
wherein said server adjusts a value included in the second policy used to create the at least one placement plan, based on results of the validation, and generates a further surplus policy.

13. A server for management of resources, comprising a processing part and a storage part,
wherein said processing part includes a placement plan generating unit that generates placement plans for virtual machines which are provided by utilizing the resources, based on a difference between a first surplus policy regarding a current surplus in the resources and a second surplus policy regarding a new surplus in the resources.

14. The server according to claim 13,
wherein said processing part includes a placement plan validating unit that validates whether each of the created placement plans for virtual machines is rejected by the second surplus policy.

15. The server according to claim 13,
wherein said processing part includes a surplus policy generating unit that generates at least one new surplus policy which has a different value from that in the second surplus policy, based on the second surplus policy regarding a given surplus in the resources, before execution of said placement plan generating unit.
